(19) United States
(12) Patent Application Publication
(10) Pub. No.: US 2021/0357871 A1
(43) Pub. Date: Nov. 18, 2021

(54) NON-TRANSITORY COMPUTER-READABLE STORAGE MEDIUM FOR STORING PROGRAM, INFORMATION PROCESSING METHOD, AND INFORMATION PROCESSING DEVICE

(71) Applicant: FUJITSU LIMITED, Kawasaki-shi (JP)

(72) Inventors: Sayuri Nakayama, Kawasaki (JP); Takuya Kamimura, Kobe (JP)

(73) Assignee: FUJITSU LIMITED, Kawasaki-shi (JP)

(21) Appl. No.: 17/218,213

(22) Filed: Mar. 31, 2021

(30) Foreign Application Priority Data
May 13, 2020 (JP) 2020-084445

(51) Int. Cl. G06Q 10/10

(52) U.S. Cl. CPC G06Q 10/1053

(57) ABSTRACT

A method includes: detecting that an index value of an event has satisfied a predetermined condition; acquiring an amount of an action related to the event in a time zone corresponding to a time point when the index value has satisfied the condition based on first information that allows identifying an action performed by a target person at each of a plurality of time points; comparing the acquired amount of the action related to the event in the time zone with an amount of an action related to the event in a past time zone; and identifying a cause corresponding to a comparison result based on second information that allows identifying, for a case where a cause for the index value to satisfy the condition has not occurred, a change tendency of an amount of an action related to the event when the cause has occurred.

### CROSS-REFERENCE TO RELATED APPLICATION

This application is based upon and claims the benefit of priority of the prior Japanese Patent Application No. 2020-84445, filed on May 13, 2020, the entire contents of which are incorporated herein by reference.

### FIELD

The embodiments discussed herein are related to a non-transitory computer-readable storage medium storing a program, an information processing method, and an information processing device.

### BACKGROUND

Conventionally, when a problem has occurred in an operation, a manager conducts an interview survey with employees or investigates an operation log recording actions of employees to grasp the action that caused the problem, and sometimes attempts to implement measures to avoid occurrence of the same problem in the future.

As a prior art, for example, there is one that creates an action feature vector of a nurse based on the measured number of steps and inclination angle of the nurse, and creates dictionary data for a specific accident based on the action feature vector when the accident has occurred. Furthermore, for example, there is a technique to generate an analytical model constituted of useful action factors needed for solving problems in an organization based on action data and communication data in the organization. In addition, for example, there is a technique to extract, from external elements of a subject or the organization to which the subject belongs, an action factor that fits an action occurrence model based on an action subject that has performed a specific action or an action external element of the organization to which the action subject belongs are extracted.

Japanese Laid-open Patent Publication No. 2004-157614, International Publication Pamphlet No. WO 2011/055628, and international Publication Pamphlet No. WO 2015/037499 are disclosed as related art.

### SUMMARY

According to an aspect of the embodiments, provided is an information processing method implemented by a computer. In an example, the method includes: detecting that an index value with respect to a predetermined event has satisfied a predetermined condition; acquiring an amount of an action related to the event in a time zone corresponding to a time point when the index value with respect to the event has satisfied the condition based on first information that allows identifying an action performed by a target person at each of a plurality of time points; comparing the acquired amount of the action related to the event in the time zone with an amount of an action related to the event in a past time zone; and identifying a cause corresponding to a comparison result based on second information that allows identifying, with respect to a case where a cause for the index value with respect to the event to satisfy the condition has not occurred, a change tendency of an amount of an action related to the event when the cause has occurred.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is an explanatory diagram illustrating an example of an information processing method according to an embodiment;

FIG. 2 is an explanatory diagram illustrating an example of an information processing system 200;

FIG. 3 is a block diagram illustrating a hardware configuration example of an information processing device 100;

FIG. 4 is an explanatory diagram illustrating an example of contents stored in an index value management table 400;

FIG. 5 is an explanatory diagram illustrating an example of contents stored in an action management table 500;

FIG. 6 is an explanatory diagram illustrating an example of contents stored in an index value threshold management table 600;

FIG. 7 is an explanatory diagram illustrating an example of contents stored in a condition management table 700;

FIG. 8 is an explanatory diagram illustrating an example of contents stored in a group management table 800;

FIG. 9 is an explanatory diagram illustrating an example of contents stored in a similarity threshold management table 900;

FIG. 10 is an explanatory diagram (No. 1) illustrating an example of contents stored in change pattern management tables 1000, 1100, 1200;

FIG. 11 is an explanatory diagram (No. 2) illustrating an example of the contents stored in the change pattern management tables 1000, 1100, 1200;

FIG. 12 is an explanatory diagram (No. 3) illustrating an example of the contents stored in the change pattern management tables 1000, 1100, 1200;

FIG. 13 is an explanatory diagram illustrating an example of contents stored in a search width management table 1300;

FIG. 14 is an explanatory diagram illustrating an example of contents stored in a related action amount management table 1400;

FIG. 15 is an explanatory diagram illustrating an example of contents stored in a normal time-related action amount management table 1500;

FIG. 16 is an explanatory diagram illustrating an example of contents stored in a margin management table 1600;

FIG. 17 is an explanatory diagram illustrating an example of contents stored in an analysis information management table 1700;

FIG. 18 is an explanatory diagram illustrating an example of contents stored in a candidate determination threshold management table 1800;

FIG. 19 is an explanatory diagram illustrating an example of contents stored in a candidate management table 1900;

FIG. 20 is a block diagram illustrating a hardware configuration example of a manager terminal 203;

FIG. 21 is a block diagram illustrating a hardware configuration example of an action recording terminal 204;

FIG. 22 is a block diagram illustrating a hardware configuration example of a state detection device 205;

FIG. 23 is a block diagram illustrating a functional configuration example of an information processing device 100;

FIG. 24 is an explanatory diagram (No. 1) illustrating an example of operation of the information processing device 100;

FIG. 25 is an explanatory diagram (No. 2) illustrating an example of operation of the information processing device 100;

FIG. 26 is an explanatory diagram (No. 3) illustrating an example of operation of the information processing device 100;

FIG. 27 is an explanatory diagram illustrating another example of a screen to be displayed;

FIG. 28 is an explanatory diagram illustrating an example of grouping actions;

FIG. 29 is an explanatory diagram illustrating a configuration example of the information processing system 200 in a first specific example;

FIG. 30 is an explanatory diagram illustrating a specific example of the functional configuration of the information processing device 100 in the first specific example;

FIG. 31 is an explanatory diagram (No. 1) illustrating a first specific example of operation of the information processing device 100;

FIG. 32 is an explanatory diagram (No. 2) illustrating a first specific example of operation of the information processing device 100;

FIG. 33 is an explanatory diagram illustrating a configuration example of an information processing system 200 in a second specific example;

FIG. 34 is an explanatory diagram illustrating a specific example of the functional configuration of the information processing device 100 in the second specific example;

FIG. 35 is an explanatory diagram illustrating a second specific example of operation of the information processing device 100; and

FIG. 36 is a flowchart illustrating an example of an overall processing procedure.

### DESCRIPTION OF EMBODIMENTS

However, with the prior art, it is difficult to grasp the action that caused the problem. For example, as the amount of data in the operation log increases, a work load on a manager when grasping the action that caused the problem increases.

In an aspect of the embodiments, there is provided a solution to identify a cause of a problem from sensing data such as time-series data with respect to actions of a target person.

Hereinafter, embodiments of an information processing program, an information processing method, and an information processing device will be described in detail with reference to the drawings.

(One Example of Information Processing Method According to Embodiment)

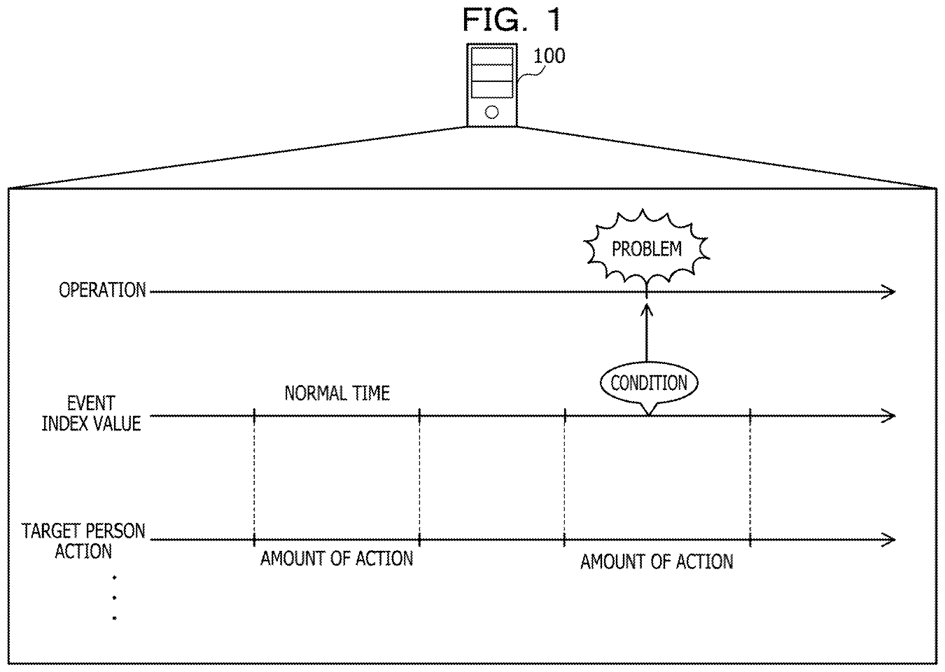

FIG. 1 is an explanatory diagram illustrating an example of an information processing method according to an embodiment. An information processing device 100 is a computer for identifying the cause that an index value with respect to a predetermined event has satisfied a predetermined condition.

Here, the predetermined event is a target to be monitored. The predetermined event is, for example, related to an operation and is a target for monitoring a state as a basis for determining whether or not a problem has occurred in the operation. The index value is a feature amount related to the predetermined event. The index value is, for example, the amount of a matter related to the predetermined event, a value for identifying a matter related to the predetermined event, or the like. The predetermined condition is a condition for determining that a problem has occurred in the operation.

Conventionally, when a problem has occurred in an operation, a manager conducts an interview survey with employees or investigates an operation log recording actions of employees to grasp the action that caused the problem, and sometimes attempts to implement measures to avoid occurrence of the same problem in the future. At this time, there may be a plurality of actions that is conceivable as the cause for one problem, and what kind of measures are needed to be implemented differs for every cause. Thus, it is desired to grasp the action that caused the problem.

However, it is difficult to grasp an action that has caused the problem. For example, as the amount of data in the operation log increases, a work load, a work time, a mental burden, and the like on the manager when grasping the action that caused the problem will increase.

Accordingly, it is conceivable to use a method that uses a model that allows identifying other actions having a relatively high probability of appearing together with a specific action that can cause a problem in the operation and, even if the specific action does not appear, outputs an alert when another action having a relatively high probability of appearing together with the specific action appears.

With this method, it is difficult to enable to grasp the action that caused the problem. For example, this method can only detect other actions that are directly related to a particular action, and may not be able to detect the action that has originally caused the problem. In other words, even if this method enables to grasp a direct or superficial reason why the problem has occurred, it may not enable to grasp an indirect or potential cause of the problem. Thus, with this method, it is not possible to reduce the work load, the work time, the mental burden, and the like on the manager.

For example, in the medical field, a case is conceivable where a problem that the waiting time of a patient for a nurse call has exceeded a permissible range. In this case, in addition to enabling to grasp a superficial reason that there have been no nurses waiting at a nurse center, it is desirable to enable to grasp a potential cause that there have been no nurses waiting at the nurse center because they provided work assistance to deal with urgent patient transport. On the other hand, it is difficult to enable to grasp the action that caused the problem.

Accordingly, in the present embodiment, an information processing method capable of identifying a cause that an index value with respect to the predetermined event has satisfied the predetermined condition will be described.

In FIG. 1, the information processing device 100 stores first information. The first information is information that allows identifying an action performed by a target person at each of a plurality of time points for every target person. The target person is, for example, a nurse in the medical field.

The information processing device 100 stores second information. The second information Is Information that allows identifying, with respect to a case where a cause for the index value with respect to the predetermined event to satisfy the predetermined condition has not occurred, a change tendency of the amount of an action related to the predetermined event when the cause has occurred. The amount of action is a statistic regarding the number of target persons who have performed the action, a statistic regarding the time when the action has been performed, a statistic regarding the size of an area where the action has been performed, or the like.

The predetermined event is, for example, a nurse call in the medical field. The index value is, for example, the waiting time of a patient for a nurse call in the medical field. The predetermined condition is, for example, that the waiting time of a patient for a nurse call has exceeded a threshold in the medical field. The predetermined condition is a condition for determining that a problem has occurred in the operation. The change tendency indicates whether the amount of an action related to the predetermined event has a tendency to increase or a tendency to decrease, for example, when a cause for the index value with respect to the predetermined event to satisfy the predetermined condition has occurred, as compared with a case where the cause has not occurred.

(1-1) The information processing device 100 detects that the index value with respect to the predetermined event has satisfied the predetermined condition. The information processing device 100 calculates, for example, the index value with respect to the predetermined event, and detects that the index value with respect to the predetermined event has satisfied the predetermined condition. For example, the information processing device 100 calculates the waiting time of a patient for a nurse call and detects that the waiting time of the patient for the nurse call has exceeded a threshold.

(1-2) The information processing device 100 acquires the amount of an action related to the predetermined event in a time zone corresponding to the time point when the index value with respect to the predetermined event has satisfied the condition based on the first information. The time zone is, for example, a time width of a predetermined length including the time point when the index value with respect to the predetermined event has satisfied the condition. The action related to the predetermined event is, for example, an action of waiting at the nurse center in the medical field. Based on the first information, for example, the information processing device 100 acquires the number of nurses having performed the action of waiting at the nurse center for ten minutes including five minutes before and after the time point when the waiting time of the patient for the nurse call has exceeded the threshold.

(1-3) The information processing device 100 compares the amount of an action related to the predetermined event in the acquired time zone with the amount of an action related to the predetermined event in a past time zone. The past time zone is a time zone in which the index value with respect to the predetermined event does not satisfy the predetermined condition, and is a time zone in which no problem has occurred in the operation. The past time zone is, for example, a normal time zone. The past time zone may be, for example, one time point in normal times.

The information processing device 100 compares, for example, the acquired number of nurses having performed an action of waiting at the nurse center with the number of nurses having performed an action of waiting at the nurse center in normal times. For example, the information processing device 100 identifies whether or not the number of nurses who have performed the action of waiting at the nurse center has a tendency to increase as compared with the normal times when the waiting time of the patient for the nurse call has exceeded the threshold.

(1-4) The information processing device 100 identifies the cause corresponding to the comparison result based on the second information. When the waiting time of the patient for the nurse call in the second information has exceeded the threshold for example, the information processing device 100 searches for a cause associated with that the number of nurses who have performed the action of waiting at the nurse center has a tendency to increase. The information processing device 100 identifies a found cause as the cause for the waiting time of the patient for the nurse call to exceed the threshold this time. The information processing device 100 outputs information indicating the identified cause so that a manager is able to refer to the information.

Thus, the information processing device 100 may identify the cause that the index value with respect to the predetermined event has satisfied the predetermined condition. In other words, the information processing device 100 may identify the cause of a problem in the operation. The information processing device 100 may make it easier for the manager to refer to information indicating an identified cause and implement measures so that the same problem does not occur in the operation in the future. Then, the information processing device 100 may reduce the work load, the work time, the mental burden, and the like on the manager.

The information processing device 100 may identify the action that has originally caused a problem in the operation based on the change tendency of the amount of an action related to the predetermined event. Therefore, the information processing device 100 may make it easy for the manager to grasp a direct or superficial reason why the problem occurred in the operation, as well as the indirect or potential cause of the problem in the operation. Then, the information processing device 100 may reduce the work load, the work time, the mental burden, and the like on the manager.

Here, the case where the information processing device 100 calculates the index value with respect to the predetermined event has been described, but the present embodiment is not limited to this. For example, the information processing device 100 may detect that the index value with respect to the predetermined event has satisfied the predetermined condition by receiving a notification that the index value with respect to the predetermined event has satisfied the predetermined condition.

(One Example of Information Processing System 200)

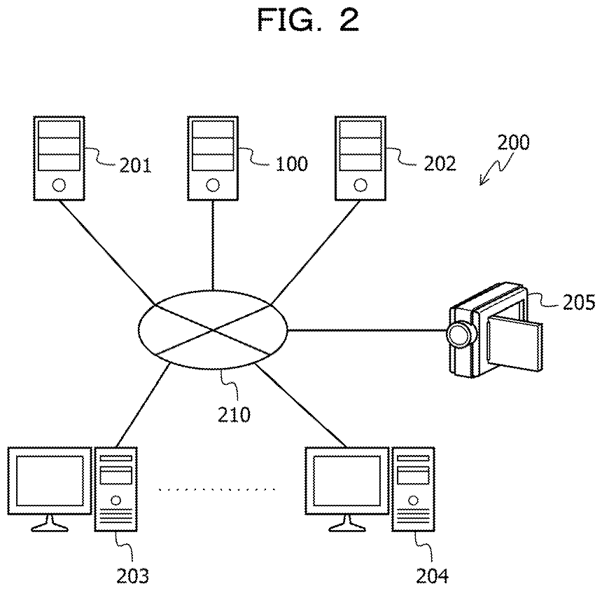

Next, an example of an information processing system 200 to which the information processing device 100 illustrated in FIG. 1 will be described with reference to FIG. 2.

FIG. 2 is an explanatory diagram illustrating an example of the information processing system 200. In FIG. 2, the information processing system 200 includes the information processing device 100, an information storage device 201, an index value management device 202, a manager terminal 203, an action recording terminal 204, and a state detection device 205.

In the information processing system 200, the information processing device 100 and the information storage device 201 are connected via a wired or wireless network 210. Examples of the network 210 include a local area network (LAN), a wide area network (WAN), the Internet, or the like. Furthermore, in the information processing system 200, the information processing device 100 and the index value management device 202 are connected via the wired or wireless network 210.

Furthermore, in the information processing system 200, the information processing device 100 and the manager terminal 203 are connected via the wired or wireless network 210. Furthermore, in the information processing system 200, the information processing device 100 and the action recording terminal 204 are connected via the wired or wireless network 210. Furthermore, in the information processing system 200, the information processing device 100 and the state detection device 205 are connected via the wired or wireless network 210.

Furthermore, in the information processing system 200, the information storage device 201 and the action recording terminal 204 are connected via the wired or wireless network 210. Furthermore, in the information processing system 200, the index value management device 202 and the action recording terminal 204 are connected via the wired or wireless network 210. Furthermore, in the information processing system 200, the action recording terminal 204 and the state detection device 205 are connected via the wired or wireless network 210.

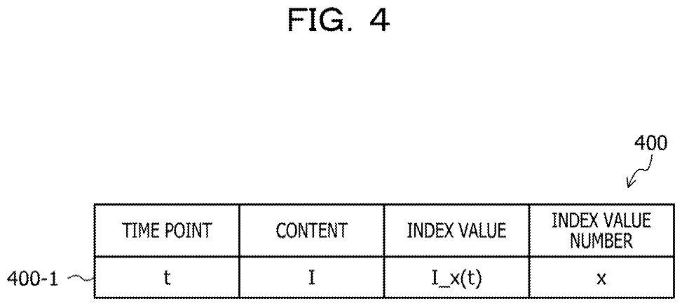

The information processing device 100 stores various tables described later in FIGS. 4 to 19. The information processing device 100 receives time-series data of the index value with respect to the predetermined event from the index value management device 202, and stores the time-series data in an index value management table 400 described later in FIG. 4.

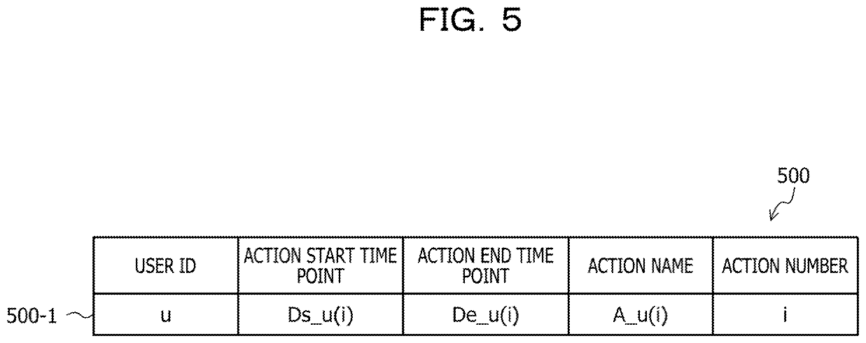

The information processing device 100 receives time-series data of actions of a target person from the information storage device 201 and stores the data in an action management table 500 described later in FIG. 5. The information processing device 100 may receive information indicating actions of a target person from the state detection device 205, generate time-series data of the actions of the target person based on the received information indicating the actions of the target person, and store the data in the action management table 500 described later in FIG. 5.

The information processing device 100 identifies a cause of a problem in the operation based on various tables described later in FIGS. 4 to 19. The information processing device 100 transmits information indicating the identified cause to the manager terminal 203. The information processing device 100 is, for example, a server, a personal computer (PC), or the like.

The information storage device 201 is a computer that stores time-series data of actions of target persons. The information storage device 201 receives information indicating actions of a target person from the action recording terminal 204, and generates and stores time-series data of the action of the target person based on the received information indicating the actions of the target person. The information storage device 201 transmits the stored time-series data of the action of the target person to the information processing device 100. The information storage device 201 is, for example, a server, a PC, or the like.

The index value management device 202 is a computer that calculates an index value with respect to the predetermined event at every time point. The index value management device 202 generates and accumulates time-series data of the index value with respect to the predetermined event based on the calculated index value. The index value management device 202 transmits the accumulated time-series data of the index value with respect to the predetermined event to the information processing device 100. The index value management device 202 is, for example, a server, a PC, or the like.

The manager terminal 203 is a computer used by a manager. The manager terminal 203 receives information indicating a cause of a problem in the operation from the information processing device 100. The manager terminal 203 outputs the received information indicating the cause so that the manager is able to refer to the information. The manager terminal 203 is, for example, a PC, a tablet terminal, a smartphone, or the like.

The action recording terminal 204 is a computer used by a target person. The action recording terminal 204 identifies an action of a target person based on an operating input of the target person. For example, the action recording terminal 204 accepts an input of an action schedule of the target person based on the operating input of the target person, and identifies the action of the target person at each time point based on the action schedule.

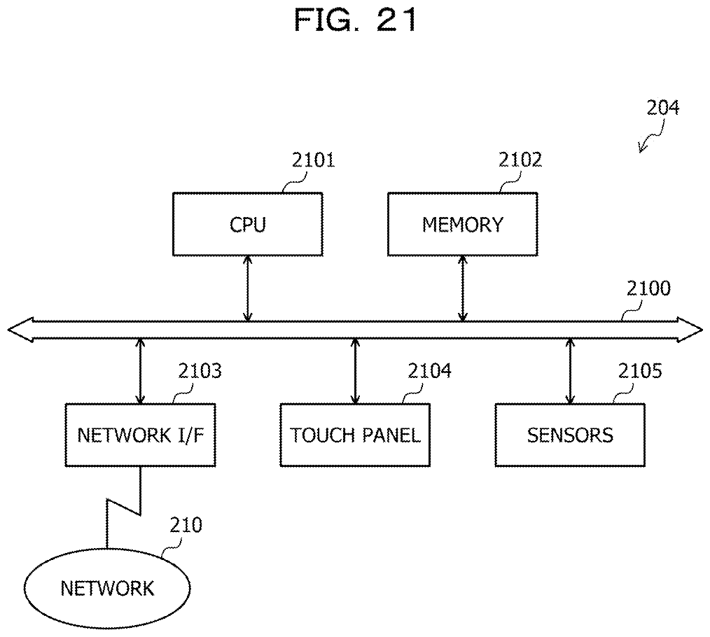

The action recording terminal 204 may identify an action of the target person based on sensors 2105 (described later in FIG. 21). For example, the action recording terminal 204 detects a state of the action recording terminal 204 as a state of the target person based on the sensors 2105 (described later in FIG. 21), and identifies the action of the target person based on the state of the target person. For example, the action recording terminal 204 associates an action with every position in advance, detects a position of the target person, and identifies an action corresponding to the detected position of the target person as the action of the target person.

The action recording terminal 204 transmits information indicating the action of the target person to the information storage device 201. The action recording terminal 204 transmits information indicating the action of the target person to the information processing device 100. The action recording terminal 204 is, for example, a PC, a tablet terminal, a smartphone, a wearable terminal, or the like.

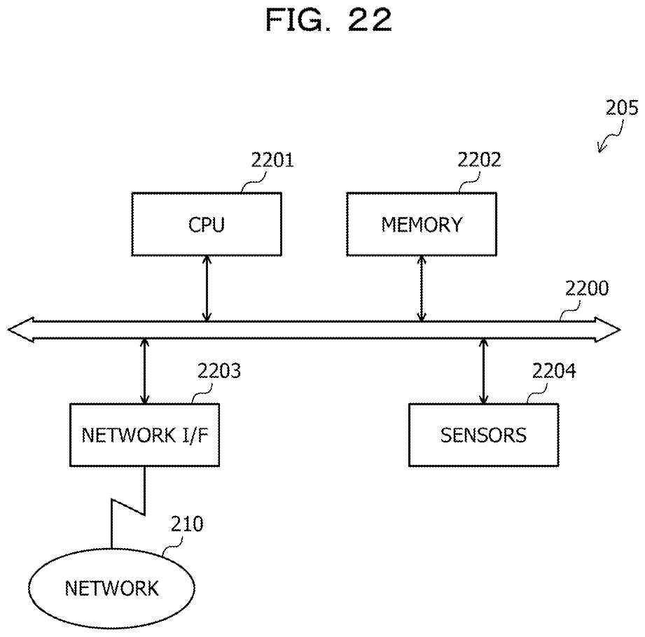

The state detection device 205 is a computer provided at a predetermined location. The state detection device 205 detects an action of a target person. The state detection device 205 detects the action of the target person based on, for example, sensors 2204 (described later in FIG. 22). For example, the state detection device 205 associates actions with every position in advance, detects a position of the target person, and identifies an action corresponding to the detected position of the target person as the action of the target person.

The state detection device 205 transmits information indicating the action of the target person to the information processing device 100. The state detection device 205 is, for example, a camera device, a card reader, an Internet of Things (IoT) device, or the like.

Here, the case where the information processing device 100 and the information storage device 201 are different devices has been described, but the present embodiment is not limited thereto. For example, the information processing device 100 may be integrated with the information storage device 201.

Here, the case where the information processing device 100 and the index value management device 202 are different devices has been described, but the present embodiment is not limited thereto. For example, the information processing device 100 may be integrated with the index value management device 202.

Here, the case where the information processing device 100 and the manager terminal 203 are different devices has been described, but the present embodiment is not limited thereto. For example, the information processing device 100 may be integrated with the manager terminal 203.

Here, the case where the information processing device 100 and the action recording terminal 204 are different devices has been described, but the present embodiment is not limited thereto. For example, the information processing device 100 may be integrated with the action recording terminal 204.

Here, the case where the information processing device 100 and the state detection device 205 are different devices has been described, but the present embodiment is not limited thereto. For example, the information processing device 100 may be integrated with the state detection device 205.

Here, the case where the information storage device 201 is a device different from the index value management device 202 has been described, but the present embodiment is not limited thereto. For example, the information storage device 201 may be integrated with the index value management device 202.

Here, the case where the information processing system 200 includes the information storage device 201, the index value management device 202, the manager terminal 203, the action recording terminal 204, and the state detection device 205 has been described, but the present embodiment is not limited thereto. For example, there may be a case where the information processing system 200 does not include at least one of the information storage device 201, the index value management device 202, the manager terminal 203, the action recording terminal 204, or the state detection device 205.

(Hardware Configuration Example of Information Processing Device 100)

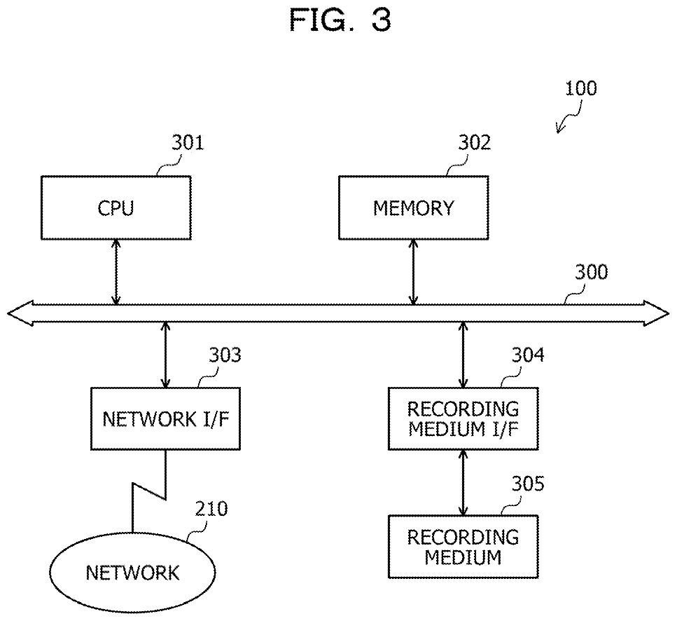

Next, a hardware configuration example of the information processing device 100 will be described with reference to FIG. 3.

FIG. 3 is a block diagram illustrating a hardware configuration example of the information processing device 100. In FIG. 3, the information processing device 100 includes a central processing unit (CPU) 301, a memory 302, a network interface (I/F) 303, a recording medium I/F 304, and a recording medium 305. Furthermore, each of those components is interconnected by a bus 300.

Here, the CPU 301 performs overall control of the information processing device 100. The memory 302 includes, for example, a read only memory (ROM), a random access memory (RAM), a flash ROM, and the like. For example, the flash ROM or the ROM stores various programs, and for example, the RAM is used as a work area for the CPU 301. The programs stored in the memory 302 are loaded into the CPU 301 to cause the CPU 301 to execute coded processing.

The network I/F 303 is connected to the network 210 through a communication line, and is connected to another computer through the network 210. Then, the network I/F 303 manages an interface between the network 210 and an inside, and controls input and output of data to and from another computer. Examples of the network I/F 303 include a modem, a LAN adapter, and the like.

The recording medium I/F 304 controls read and write of data to and from the recording medium 305 under the control of the CPU 301. The recording medium I/F 304 is, for example, a disk drive, a solid state drive (SSD), a universal serial bus (USB) port, or the like. The recording medium 305 is a nonvolatile memory that stores data written under the control of the recording medium I/F 304. The recording medium 305 is, for example, a disk, a semiconductor memory, a USB memory, or the like. The recording medium 305 may be removably installed on the information processing device 100.

The information processing device 100 may further include, for example, a keyboard, a mouse, a display, a printer, a scanner, a microphone, a speaker, or the like in addition to the above-described components. Furthermore, the information processing device 100 may include a plurality of the recording media I/F 304 and the recording media 305. Furthermore, the information processing device 100 may omit the recording medium I/F 304 and the recording medium 305.

(Contents Stored in Index Value Management Table 400)

Next, an example of part of contents stored in the index value management table 400 will be described with reference to FIG. 4. The index value management table 400 is implemented by a storage area such as the memory 302 or the recording medium 305 of the information processing device 100 illustrated in FIG. 3, for example.

FIG. 4 is an explanatory diagram illustrating an example of the contents stored in the index value management table 400. As illustrated in FIG. 4, the index value management table 400 has fields of time point, content, index value, and index value number. In the index value management table 400, index value management information is stored as a record 400-a by setting information in every field at each time point. a is any integer.

In the time point field, a time point t when an index value is measured is set. In the content field, a descriptive text indicating an index value type I is set. In the index value field, an index value I_x(t) belonging to a type I to which an index value number x is assigned at the time point t is set. In the index value number field, an index value number x assigned to the index value type I is set.

(Contents Stored in Action Management Table 500)

Next, an example of contents stored in the action management table 500 will be described with reference to FIG. 5. The action management table 500 is implemented by a storage area such as the memory 302 or the recording medium 305 of the information processing device 100 illustrated in FIG. 3, for example.

FIG. 5 is an explanatory diagram illustrating an example of the contents stored in the action management table 500. As illustrated in FIG. 5, the action management table 500 has fields of user ID, action start time point, action end time point, action name, and action number. In the action management table 500, action management information Is stored as a record 500-a by setting information in each field for every user. a is any integer.

In the user ID field, user ID=u that identifies a target person is set. In the action start time point field, an action start time point Ds_u(i) indicating a time point when the target person starts an action is set. In the action end time point field, an action end time point De_u(i) Indicating a time point when the target person finishes the action is set. In the action name field, an action name A_u(i) of the action is set. In the action number field, an action number i assigned to the action name is set.

(Contents Stored in Index Value Threshold Management Table 600)

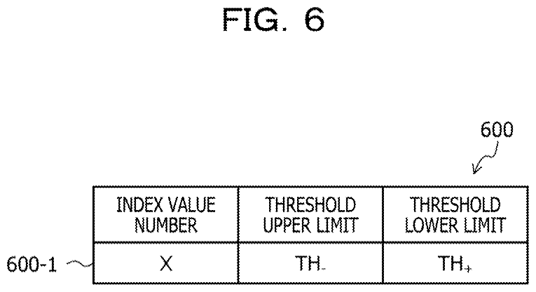

Next, an example of contents stored in an index value threshold management table 600 will be described with reference to FIG. 6. The index value threshold management table 600 is implemented by a storage area such as the memory 302 or the recording medium 305 of the information processing device 100 illustrated. In FIG. 3, for example.

FIG. 6 is an explanatory diagram illustrating an example of the contents stored in the index value threshold management table 600. As illustrated in FIG. 6, the index value threshold management table 600 has fields of index value number, threshold upper limit, and threshold lower limit. In the index value threshold management table 600, threshold information is stored as a records 600-a by setting information in each field for every index value. a is any integer.

In the index value number field, an index value number x assigned to the index value type I is set. In the threshold upper limit field, a threshold upper limit TH₋ used for threshold determination for the type I index value is set. The threshold determination is performed, for example, when occurrence of a problem is detected. In the threshold lower limit field, a threshold lower limit TH₊ used for threshold determination for the type I index value is set.

(Contents Stored in Condition Management Table 700)

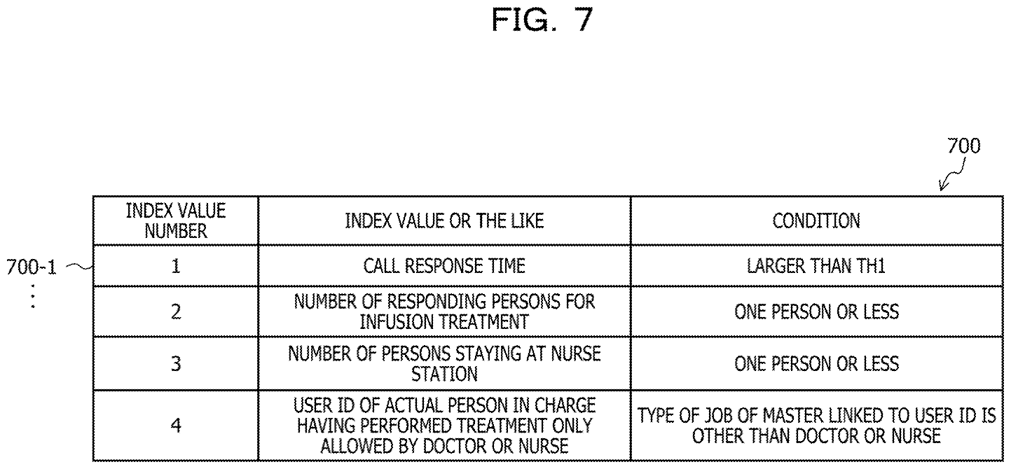

Next, an example of contents stored in a condition management table 700 will be described with reference to FIG. 7. The condition management table 700 is implemented by a storage area such as the memory 302 or the recording medium 305 of the information processing device 100 illustrated in FIG. 3, for example.

FIG. 7 is an explanatory diagram illustrating an example of the contents stored in the condition management table 700. As illustrated in FIG. 7, the condition management table 700 has fields of index value number, index value or the like, and condition. In the condition management table 700, condition information is stored as a record 700-a by setting information in each field for every index value. a is any integer.

In the index value number field, an index value number x assigned to the type I′ of the index value or the like is set. In the field of index value and the like, a descriptive text indicating the type I′ of the index value or the like is set. In the condition field, a condition for the index value or the like is set. The condition is a condition for determining occurrence of a problem in the operation.

(Contents Stored in Group Management Table 800)

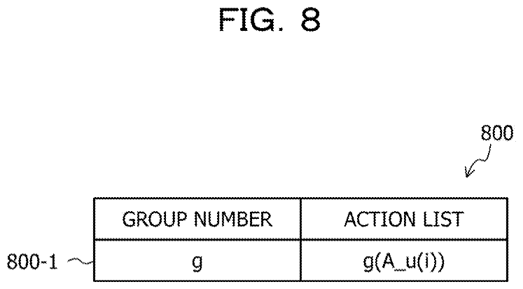

Next, an example of contents stored in a group management table 800 will be described with reference to FIG. 8. The group management table 800 is implemented by a storage area such as the memory 302 or the recording medium 305 of the information processing device 100 illustrated in FIG. 3, for example.

FIG. 8 is an explanatory diagram illustrating an example of the contents stored in the group management table 800. As illustrated in FIG. 8, the group management table 800 has fields of group number and action list. In the group management table 800, group management information is stored as a record 800-a by setting information in each field for every group. a is any integer.

In the group number field, a group number assigned to an action name group is set. The action name group is a group including similar action names. In the action list field, a list of action names belonging to the action name group is set.

(Contents Stored in Similarity Threshold Management Table 900)

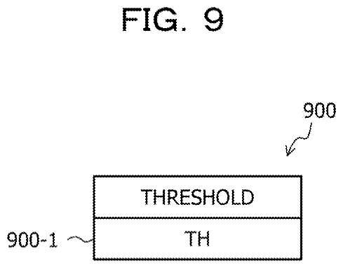

Next, an example of contents stored in a similarity threshold management table 900 will be described with reference to FIG. 9. The similarity threshold management table 900 is implemented by a storage area such as the memory 302 or the recording medium 305 of the information processing device 100 illustrated in FIG. 3, for example.

FIG. 9 is an explanatory diagram illustrating an example of the contents stored in the similarity threshold management table 900. As illustrated in FIG. 9, the similarity threshold management table 900 has a threshold field. In the similarity threshold management table 900, threshold information is stored as a record 900-a by setting information in each field. a is any integer.

In the threshold field, a threshold TH used for threshold determination for similarity of action names is set.

(Contents Stored in Change Pattern Management Tables 1000, 1100, 1200)

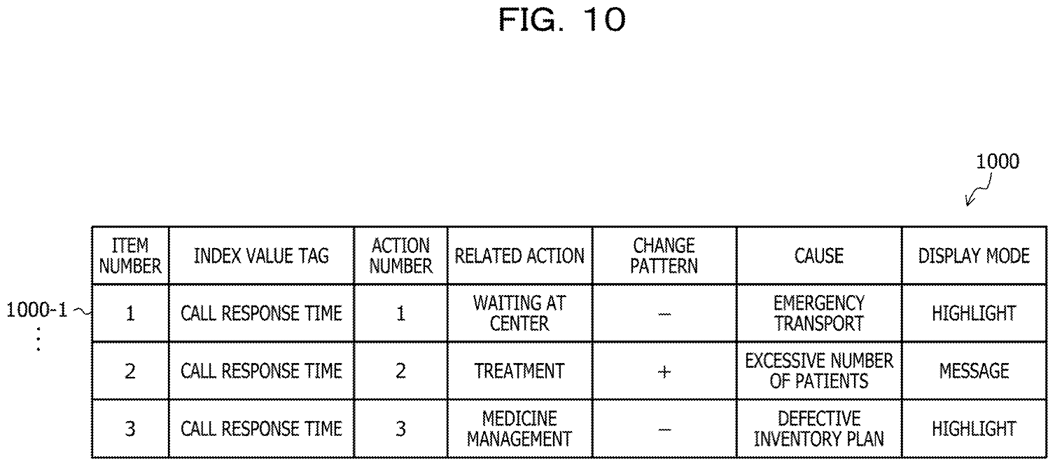

Next, an example of contents stored in change pattern management tables 1000, 1100, 1200 will be described with reference to FIGS. 10 to 12. The change pattern management tables 1000, 1100, 1200 are implemented by a storage area such as the memory 302 or the recording medium 305 of the information processing device 100 illustrated in FIG. 3, for example.

FIGS. 10 to 12 are explanatory diagrams illustrating examples of the contents stored in the change pattern management tables 1000, 1100, 1200. As illustrated in FIG. 10, the change pattern management table 1000 has fields of item number, index value tag, action number, related action, change pattern, cause, and display mode. In the change pattern management table 1000, change pattern management information is stored as a record 1000-a by setting information in each field for every cause of a problem in the operation. a is any integer.

In the item number field, an item number assigned to change pattern management information is set. In the index value tag field, an index value type I or an index value number x assigned to the index value type I or the like is set. In the action number field, a number assigned to an action name of a related action is set that is to be focused on when identifying a cause that the type I index value has satisfied a condition. In the related action field, an action name of a related action is set that is to be focused on when identifying a cause that the type I index value has satisfied a condition.

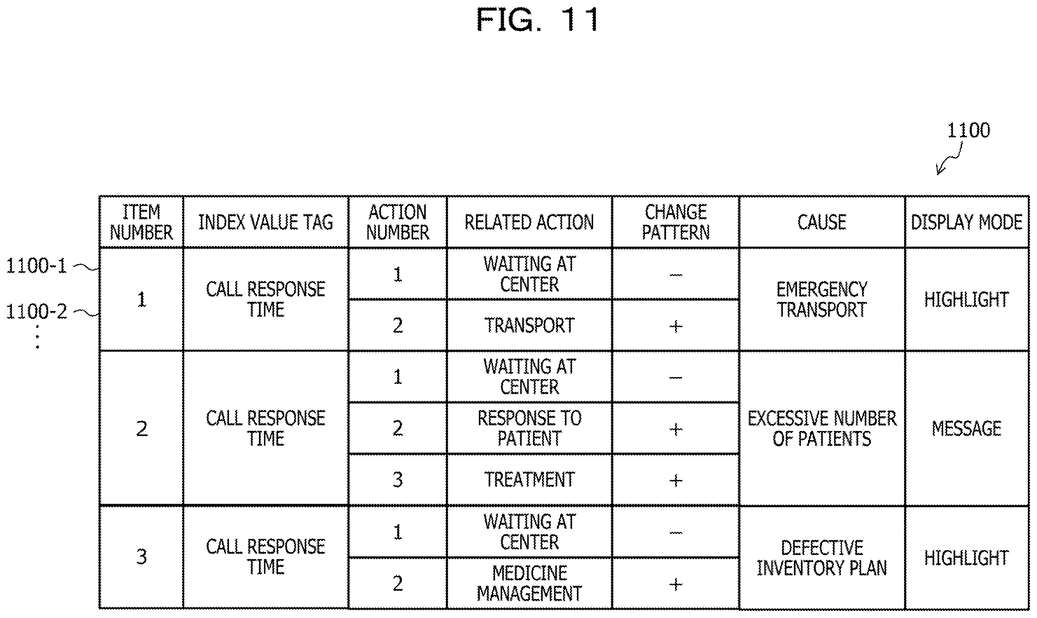

In the change pattern field, a change pattern is set to indicate what kind of change appears in the action amount of a related action when a cause for a problem in the operation has occurred as compared with normal times. When the change pattern is +, it means to have a tendency to increase. When the change pattern is −, it means to have a tendency to decrease. In the cause field, information indicating a cause for a problem in the operation is set. In the display mode field, Information identifying a display mode when displaying information indicating a cause for a problem in the operation is set. Next, description of FIG. 11 will be made, and the change pattern management table 1100, which is another example of the change pattern management table 1000, will be described.

As Illustrated in FIG. 11, the change pattern management table 1100 has fields of item number, index value tag, action number, related action, change pattern, cause, and display mode. In the change pattern management table 1100, change pattern management information is stored as a record 1100-a by setting information in each field for every cause of a problem in the operation. a is any integer.

In the item number field, an item number assigned to change pattern management information is set. In the index value tag field, an index value type I or an index value number x assigned to the index value type I or the like is set. In the action number field, a number assigned to an action name of a related action is set that is to be focused on when identifying a cause that the type I index value has satisfied a condition. In the related action field, an action name of a related action is set that is to be focused on when identifying a cause that the type I index value has satisfied a condition.

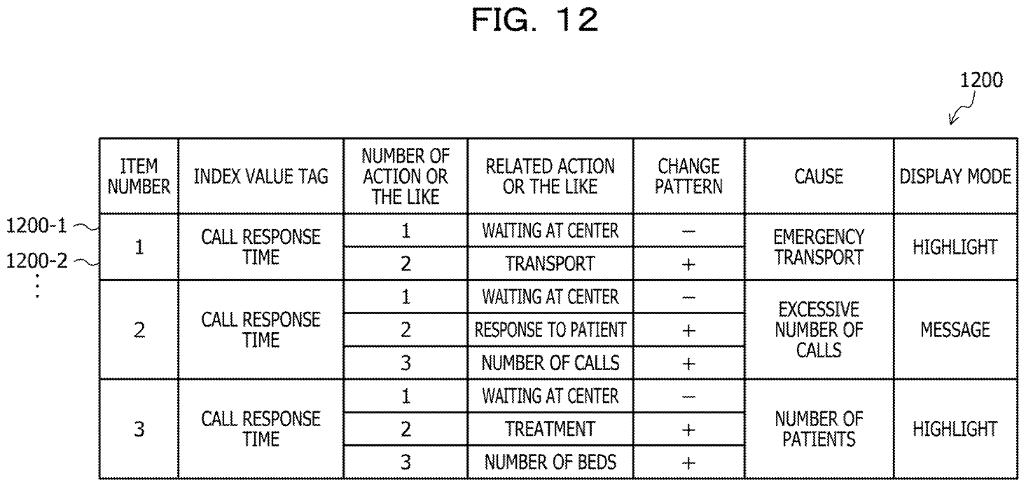

In the change pattern field, a change pattern is set to indicate what kind of change appears in the action amount of a related action when a cause for a problem in the operation has occurred as compared with normal times. When the change pattern is +, it means to have a tendency to increase. When the change pattern is −, it means to have a tendency to decrease. In the cause field, information indicating a cause for a problem in the operation is set. In the display mode field, information identifying a display mode when displaying information indicating a cause for a problem in the operation is set. Next, description of FIG. 12 will be made, and the change pattern management table 1200, which is another example of the change pattern management tables 1000, 1100, will be described.

As Illustrated in FIG. 12, the change pattern management table 1200 has fields of item number, index value tag, number of action or the like, related action or the like, change pattern, cause, and display mode. In the change pattern management table 1200, change pattern management information is stored as a record 1200-a by setting information in each field for every cause of a problem in the operation. a is any integer.

In the item number field, an item number assigned to change pattern management information is set. In the index value tag field, an index value type I or an index value number x assigned to the index value type I or the like is set. In the field of number of action or the like, an action name of a related action or a number assigned to another index value is set that is to be focused on when identifying a cause that the type I index value has satisfied a condition. In the field or related action or the like, an action name of a related action or a descriptive text indicating the type of another index value is set that is to be focused on when identifying a cause that the type I index value has satisfied a condition.

In the change pattern field, a change pattern is set to indicate what kind of change appears in the action amount of a related action or a statistical value of another index value when a cause for a problem in the operation has occurred as compared to normal times. When the change pattern is +, it means to have a tendency to increase. When the change pattern is −, it means to have a tendency to decrease. In the cause field, information indicating a cause for a problem in the operation is set. In the display mode field, information identifying a display mode when displaying information indicating a cause for a problem in the operation is set.

(Contents Stored in Search Width Management Table 1300)

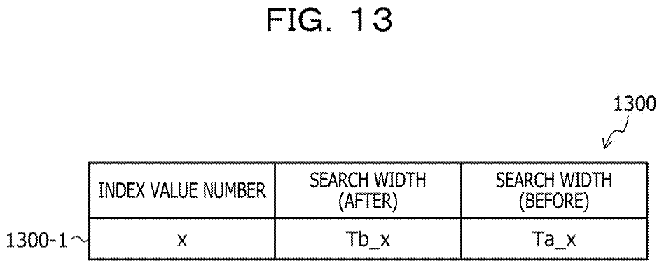

Next, an example of contents stored in a search width management table 1300 will be described with reference to FIG. 13. The search width management table 1300 is implemented by a storage area such as the memory 302 or the recording medium 305 of the information processing device 100 illustrated in FIG. 3, for example.

FIG. 13 is an explanatory diagram illustrating an example of the contents stored in the search width management table 1300. As illustrated in FIG. 13, the search width management table 1300 has fields of index value number, search width (before), and search width (after). In the search width management table 1300, search width information is stored as a record 1300-a by setting information in each field for every type of an index value. a is any integer.

In the index value number field, an index value number x assigned to the index value type I is set. In the search width (before) field, when a type I index value has satisfied a condition, a search width (before) is set for identifying a time zone for calculating the amount of a related action on the basis of a time point when the type I index value has satisfied the condition. The search width (before) is a value of 0 or more, and in units of seconds, minutes, hours, or the like. In the search width (after) field, when a type I index value has satisfied a condition, a search width (after) is set for identifying a time zone for calculating the amount of a related action on the basis of a time point when the type I index value has satisfied the condition. The search width (after) is a value of 0 or more, and in units of seconds, minutes, hours, or the like.

(Contents Stored in Related Action Amount Management Table 1400)

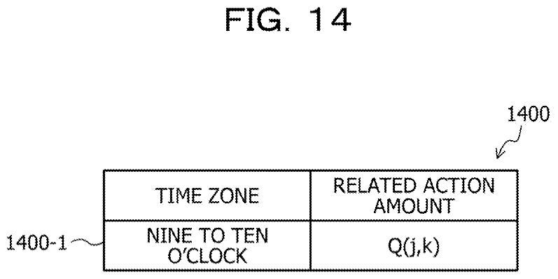

Next, an example of contents stored in a related action amount management table 1400 will be described with reference to FIG. 14. The related action amount management table 1400 is implemented by a storage area such as the memory 302 or the recording medium 305 of the information processing device 100 illustrated in FIG. 3, for example.

FIG. 14 is an explanatory diagram illustrating an example of the contents stored in the related action amount management table 1400. As illustrated in FIG. 14, the related action amount management table 1400 has fields of time zone and related action amount. In the related action amount management table 1400, related action amount management information is stored as a record 1400-a by setting information in each field for every time zone. a is any integer.

In the time zone field, a time zone in which the amount of a related action is calculated is set. The time zone is, for example, a period of a predetermined length on the basis of a time point when an index value with respect to the predetermined event has satisfied a condition. The time zone is, for example, any of respective preset periods, such as between 0 and 1 o'clock, between 1 and 2 o'clock, and between 2 and 3 o'clock, including the time point when the index value with respect to the predetermined event has satisfied the predetermined condition. In the related action amount field, the amount of a related action in the time zone is set. The amount of a related action is a statistic with respect to the number of target persons who have performed a related action, a statistic with respect to a time when the related action has been performed, a statistic with respect to the size of an area where the related action has been performed, or the like.

The related action amount management table 1400 may further have a related index value field. In the related index value field, a statistical value of a related index value in the time zone is set.

(Contents Stored in Normal Time-Related Action Amount Management Table 1500)

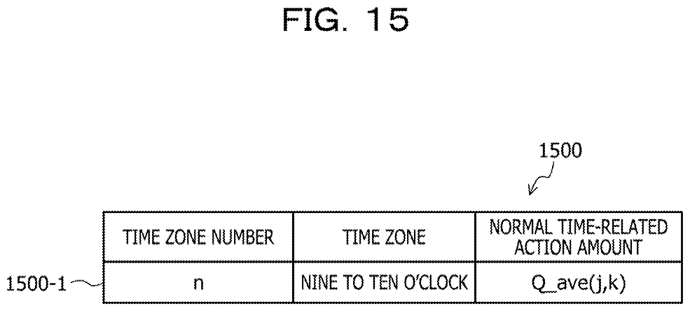

Next, an example of contents stored in the normal time-related action amount management table 1500 will be described with reference to FIG. 15. The normal time-related action amount management table 1500 is implemented by a storage area such as the memory 302 or the recording medium 305 of the information processing device 100 illustrated in FIG. 3, for example.

FIG. 15 is an explanatory diagram illustrating an example of the contents stored in the normal time-related action amount management table 1500. As illustrated in FIG. 15, the normal time-related action amount management table 1500 has fields of time zone number, time zone, and normal time-related action amount. In the normal time-related action amount management table 1500, normal time-related action amount management information is stored as a record 1500-a by setting information in each field for every time zone. a is any integer.

In the time zone number field, a time zone number assigned to a normal time zone in which the amount of a related action is calculated is set. In the time zone field, a normal time zone in which the amount of a related action is calculated is set. The normal time zone is, for example, any of respective preset periods, such as between 0 and 1 o'clock, between 1 and 2 o'clock, and between 2 and 3 o'clock, including the time point when the index value with respect to the predetermined event has satisfied the predetermined condition. In the field of normal time-related action amount, the amount of a related action in the normal time zone is set. The amount of a related action is a statistic with respect to the number of target persons who have performed a related action, a statistic with respect to a time when the related action has been performed, a statistic with respect to the size of an area where the related action has been performed, or the like.

The normal time-related action amount management table 1500 may further have a normal time-related index value field. In the normal time related index value field, a statistical value of the related index value in the normal time zone is set.

(Contents Stored in Margin Management Table 1600)

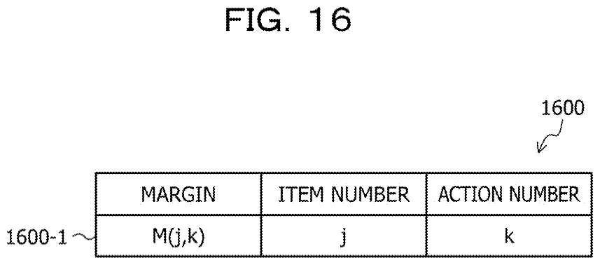

Next, an example of contents stored in a margin management table 1600 will be described with reference to FIG. 16. The margin management table 1600 is implemented by a storage area such as the memory 302 or the recording medium 305 of the information processing device 100 illustrated in FIG. 3, for example.

FIG. 16 is an explanatory diagram illustrating an example of the contents stored in the margin management table 1600. As illustrated in FIG. 16, the margin management table 1600 has fields of margin, item number, and action number. In the margin management table 1600, margin management information is stored as a record 1600-a by setting information in each field for every pair of the item number and the action number. a is any integer.

In the margin field, a margin used when verifying whether or not a change pattern of the related action this time is a change pattern corresponding to the pair of the item number and the action number is set. In the item number field, an item number for identifying the change pattern to be verified is set. In the action number field, an action number for identifying the change pattern to be verified is set.

(Contents Stored in Analysis Information Management Table 1700)

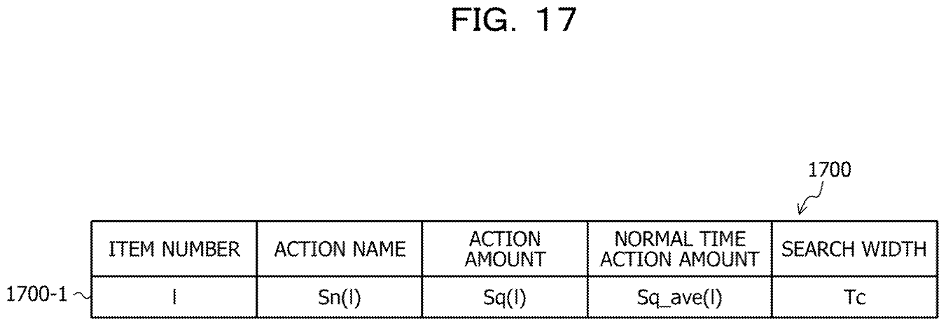

Next, an example of contents stored in an analysis information management table 1700 will be described with reference to FIG. 17. The analysis information management table 1700 is implemented by a storage area such as the memory 302 or the recording medium 305 of the information processing device 100 illustrated in FIG. 3, for example.

FIG. 17 is an explanatory diagram illustrating an example of the contents stored in the analysis information management table 1700. As illustrated in FIG. 17, the analysis information management table 1700 has fields of action number, action name, action amount, normal time action amount, and search width. In the analysis information management table 1700, analysis information is stored as a record 1700-a by setting information in each field for every action. a is any integer.

In the action number field, an action number I assigned to an action that can be an action that causes a problem in the operation is set. In the action name field, an action name Sn(I) of an action that can be an action that causes a problem in the operation is set. In the action amount field, an amount of action Sq(I) that can be an action that causes a problem in the operation in the time zone on the basis of the time point when the type I index value has satisfied the condition is set. In the normal time action amount field, the amount of action Sq_ave(I) that can be an action that causes a problem in the operation in normal time is set. In the search width field, a search width Tc for identifying a normal time is set.

(Contents Stored in Candidate Determination Threshold Management Table 1800)

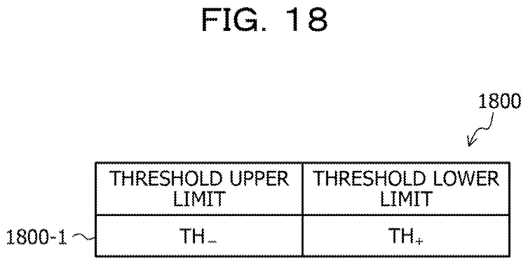

Next, an example of contents stored in a candidate determination threshold management table 1800 will be described with reference to FIG. 18. The candidate determination threshold management table 1800 is implemented by a storage area such as the memory 302 or the recording medium 305 of the information processing device 100 illustrated in FIG. 3, for example.

FIG. 18 is an explanatory diagram illustrating an example of the contents stored in the candidate determination threshold management table 1800. As illustrated in FIG. 18, the candidate determination threshold management table 1800 has fields of threshold upper limit and threshold lower limit. In the candidate determination threshold management table 1800, threshold information is stored as a record 1800-a by setting information in each field. a is any integer.

In the threshold upper limit field, a threshold upper limit TH₋ used when determining whether or not any action causes a problem in the operation is set. In the threshold lower limit field, a threshold lower limit TH₊ used when determining whether or not any action causes a problem in the operation is set.

(Contents Stored in Candidate Management Table 1900)

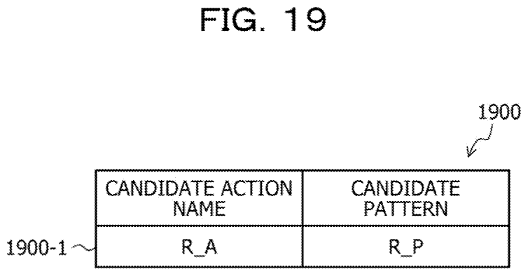

Next, an example of contents stored in a candidate management table 1900 will be described with reference to FIG. 19. The candidate management table 1900 is implemented by a storage area such as the memory 302 or the recording medium 305 of the information processing device 100 illustrated in FIG. 3, for example.

FIG. 19 is an explanatory diagram illustrating an example of the contents stored in the candidate management table 1900. As illustrated in FIG. 19, the candidate management table 1900 has fields of candidate action name and candidate pattern. In the candidate management table 1900, candidate management information is stored as a record 1900-a by setting the information in each field. a is any integer.

In the candidate action name field, an action name R_A of an action that can cause a problem in the operation is set. In the candidate pattern field, a candidate that can be a change pattern indicating how the amount of action changes when a problem occurs in the operation is set.

(Hardware Configuration Example of Manager Terminal 203)

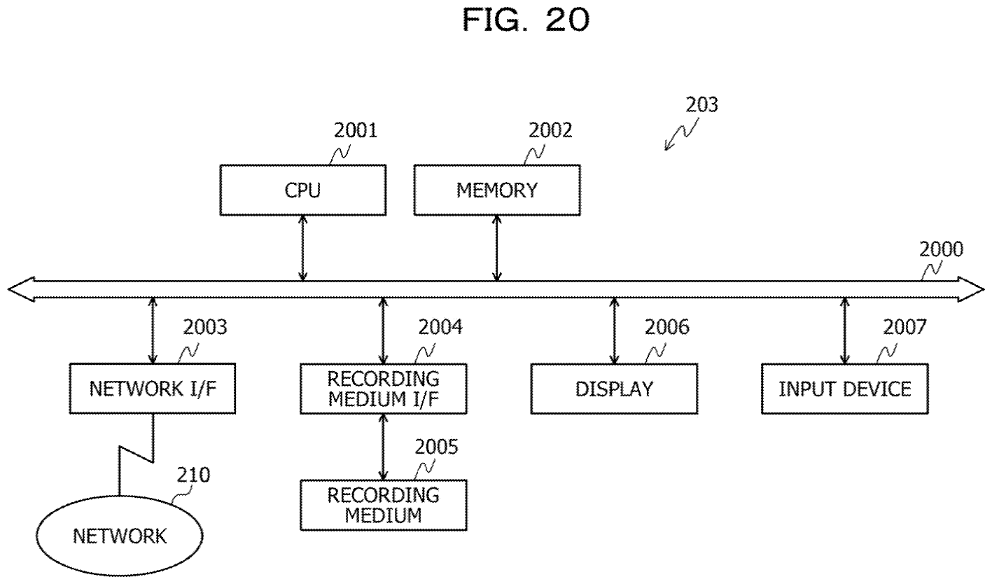

Next, a hardware configuration example of the manager terminal 203 included in the information processing system 200 illustrated in FIG. 2 will be described with reference to FIG. 20.

FIG. 20 is a block diagram illustrating a hardware configuration example of the manager terminal 203. In FIG. 20, the manager terminal 203 includes a CPU 2001, a memory 2002, a network I/F 2003, a recording medium I/F 2004, a recording medium 2005, a display 2006, and an input device 2007. Furthermore, each of these components is interconnected by a bus 2000.

Here, the CPU 2001 performs overall control of the manager terminal 203. The memory 2002 includes, for example, a ROM, a RAM, a flash ROM, and the like. For example, the flash ROM or the ROM stores various programs, and for example, the RAM is used as a work area for the CPU 2001. The programs stored in the memory 2002 are loaded into the CPU 2001 to cause the CPU 2001 to execute coded processing.

The network I/F 2003 is connected to the network 210 through a communication line, and is connected to another computer through the network 210. Then, the network I/F 2003 manages an interface between the network 210 and an inside, and controls input and output of data to and from another computer. The network I/F 2003 is, for example, a modem, a LAN adapter, or the like.

The recording medium I/F 2004 controls read and write of data to and from the recording medium 2005 under the control of the CPU 2001. The recording medium I/F 2004 is, for example, a disk drive, an SSD, a USB port, or the like. The recording medium 2005 is a nonvolatile memory that stores data written under the control of the recording medium I/F 2004. The recording medium 2005 is, for example, a disk, a semiconductor memory, a USB memory, or the like. The recording medium 2005 may be detachable from the manager terminal 203.

The display 2006 displays data such as a document, an image, function information, and the like, as well as a cursor, an icon, or a tool box. The display 2006 is, for example, a cathode ray tube (CRT), a liquid crystal display, an organic electroluminescence (EL) display, or the like. The input device 2007 has keys for inputting characters, numbers, various instructions, and the like, and inputs data. The input device 2007 may be a keyboard, a mouse, or the like, or may be a touch-panel input pad, a numeric keypad, or the like.

The manager terminal 203 may have, for example, a printer, a scanner, a microphone, a speaker, and the like, in addition to the above-described components. Furthermore, the manager terminal 203 may have a plurality of the recording media I/F 2004 and the recording media 2005. Furthermore, the manager terminal 203 may omit the recording medium I/F 2004 and the recording medium 2005.

(Hardware Configuration Example of Action Recording Terminal 204)

Next, a hardware configuration example of the action recording terminal 204 included in the information processing system 200 illustrated in FIG. 2 will be described with reference to FIG. 21.

FIG. 21 is a block diagram illustrating a hardware configuration example of the action recording terminal 204. In FIG. 21, the action recording terminal 204 has a CPU 2101, a memory 2102, a network I/F 2103, a touch panel 2104, and sensors 2105. Furthermore, each of these components is interconnected by a bus 2100.

Here, the CPU 2101 performs overall control of the action recording terminal 204. The memory 2102 includes, for example, a ROM, a RAM, a flash ROM, and the like. For example, the flash ROM or the ROM stores various programs, and for example, the RAM is used as a work area for the CPU 2101. The programs stored in the memory 2102 are loaded into the CPU 2101 to cause the CPU 2101 to execute coded processing.

The network I/F 2103 is connected to the network 210 through a communication line, and is connected to another computer through the network 210. Then, the network I/F 2103 manages an interface between the network 210 and an inside, and controls input and output of data to and from another computer.

The touch panel 2104 has a display that displays data such as a document, an image, or function information, as well as a cursor, an icon or a tool box. The touch panel 2104 is provided on the display or on an outer peripheral portion of the display, and has a detection device that detects a contact position of a user on the touch panel 2104. The detection device detects the contact position by using, for example, a resistance film method, a capacitance method, an ultrasonic method, an optical method, an electromagnetic induction method, or the like. The touch panel 2104 inputs characters, numbers, various instructions, and the like according to the contact position of the user.

The sensors 2105 detect a state of the action recording terminal 204. The sensors 2105 detect, for example, at least one of a position, a movement, or an orientation of the action recording terminal 204. For example, the sensors 2105 have an acceleration sensor. Furthermore, the sensors 2105 may have at least one of a geomagnetic sensor, an optical sensor, a vibration sensor, or the like. In addition, the sensors 2105 may include a global positioning system (GPS) receiver, and may detect GPS coordinates of the action recording terminal 204.

The sensors 2105 acquire biological information. The sensors 2105 acquire, for example, information regarding pulses, body temperatures, or the like as biological information. The sensors 2105 have a microphone and acquire voice information. The sensors 2105 have a communication circuit for short-range communication and detect the position of the action recording terminal 204. The communication circuit for short-range communication is, for example, a communication circuit having an antenna for Wi-Fi (registered trademark). The action recording terminal 204 may have, for example, a disk drive, a disk, an SSD, a semiconductor memory, a scanner, a printer, or the like, in addition to the above-described components.

(Hardware Configuration Example of State Detection Device 205)

Next, a hardware configuration example of the state detection device 205 included in the information processing system 200 illustrated in FIG. 2 will be described with reference to FIG. 22.

FIG. 22 is a block diagram illustrating a hardware configuration example of the state detection device 205. In FIG. 22, the state detection device 205 has a CPU 2201, a memory 2202, a network I/F 2203, and sensors 2204. Furthermore, each of these components is interconnected by a bus 2200.

Here, the CPU 2201 performs overall control of the state detection device 205. The memory 2202 includes, for example, a ROM, a RAM, a flash ROM, and the like. For example, the flash ROM or the ROM stores various programs, and for example, the RAM is used as a work area for the CPU 2201. The programs stored in the memory 2202 are loaded into the CPU 2201 to cause the CPU 2201 to execute coded processing.

The network I/F 2203 is connected to the network 210 through a communication line, and is connected to another computer through the network 210. Then, the network I/F 2203 manages an interface between the network 210 and an inside, and controls input and output of data to and from another computer.

The sensors 2204 detect a state of a target person. The sensors 2204 detect, for example, at least one of a position, a movement, or an orientation of the target person. The sensors 2204 acquire biological information, for example. The sensors 2204 acquire, for example, information regarding fingerprints, facial features, or the like as biological information, and detect the state of the target person. The sensors 2204 include, for example, an image pickup device, recognize the facial features of the target person reflected in the captured image captured by the image pickup device, and detect the state of the target person. The state detection device 205 may have, for example, a disk drive, a disk, an SSD, a semiconductor memory, a scanner, a printer, or the like, in addition to the above-described components.

(Functional Configuration Example of Information Processing Device 100)

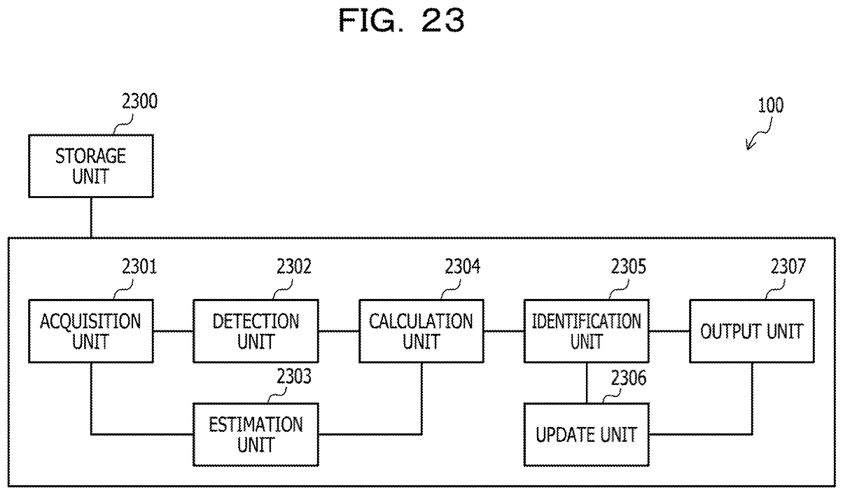

Next, a functional configuration example of the information processing device 100 will be described with reference to FIG. 23.

FIG. 23 is a block diagram illustrating a functional configuration example of the information processing device 100. The information processing device 100 includes a storage unit 2300, an acquisition unit 2301, a detection unit 2302, an estimation unit 2303, a calculation unit 2304, an identification unit 2305, an update unit 2306, and an output unit 2307.

The storage unit 2300 is implemented by a storage area such as the memory 302 or the recording medium 305 illustrated in FIG. 3, for example. Hereinafter, the case in which the storage unit 2300 is included in the information processing device 100 will be described. However, the embodiment is not limited to this case. For example, the storage unit 2300 may be included in a device different from the information processing device 100, and contents stored in the storage unit 2300 may be able to be referred to by the information processing device 100.

The acquisition unit 2301 to the output unit 2307 function as an example of a control unit. For example, the acquisition unit 2301 to the output unit 2307 implement functions thereof by causing the CPU 301 to execute a program stored in the storage area of the memory 302, the recording medium 305, or the like illustrated in FIG. 3 or by the network I/F 303. A processing result of each function unit is stored in, for example, the storage area of the memory 302, the recording medium 305, or the like illustrated in FIG. 3.

The storage unit 2300 stores various types of information referred to or updated in the processing of each function unit. The storage unit 2300 stores time-series data of an index value with respect to the predetermined event. The predetermined event is, for example, an event related to the operation. The predetermined event is, for example, a nurse call in the medical field. The index value is, for example, a physical quantity related to the predetermined event. The index value may be, for example, a value that identifies a target person who has performed an action related to the predetermined event. The index value is, for example, the waiting time of a patient for a nurse call in the medical field. The time-series data of the index value is stored using, for example, the index value management table 400 illustrated in FIG. 4. The storage unit 2300 stores, for example, the index value management table 400 illustrated in FIG. 4.

The storage unit 2300 stores the predetermined condition. The predetermined condition is a condition related to the index value with respect to the predetermined event. The predetermined condition is, for example, a condition for determining that a problem has occurred in the operation based on the index value with respect to the predetermined event. The predetermined condition is, for example, that the index value with respect to the predetermined event is out of a predetermined range. The predetermined condition may be, for example, that the target person identified by the index value is other than a specific target person. The predetermined condition is, for example, that the waiting time of a patient for a nurse call has exceeded a threshold in the medical field. The predetermined condition is stored using, for example, the index value threshold management table 600 illustrated in FIG. 6 or the condition management table 700 illustrated in FIG. 7. The storage unit 2300 stores, for example, the index value threshold management table 600 illustrated in FIG. 6 or the condition management table 700 illustrated in FIG. 7.

The storage unit 2300 stores first information. The first information is information that allows identifying an action performed by a target person at each of a plurality of time points for every target person. The target person is, for example, a person involved in the operation. The target person is, for example, a medical worker such as a doctor or a nurse in the medical field. The first information is stored, for example, using the action management table 500 illustrated in FIG. 5. The storage unit 2300 stores, for example, the action management table 500 illustrated in FIG. 5.

The storage unit 2300 stores information indicating a group of actions. A group of actions is, for example, a group of actions having similar action names. Information indicating a group of actions is stored, for example, using the group management table 800 illustrated in FIG. 8. The storage unit 2300 stores, for example, the group management table 800 illustrated in FIG. 8. The storage unit 2300 stores a threshold used for a similar determination. The storage unit 2300 stores, for example, the similarity threshold management table 900 illustrated in FIG. 9.

The storage unit 2300 stores the second information. The second information is information that allows identifying, with respect to a case where a cause for the index value with respect to the predetermined event to satisfy the predetermined condition has not occurred, a change tendency of the amount of one or more actions related to the predetermined event when the cause has occurred. The amount of action is a statistic regarding the number of target persons who have performed the action, a statistic regarding the time when the action has been performed, a statistic regarding the size of an area where the action has been performed, or the like. The statistic is, for example, total, maximum, minimum, mean, mode, median, variance, standard deviation, or the like. The change tendency indicates whether the amount of an action related to the predetermined event has a tendency to increase or a tendency to decrease, for example, when a cause for the index value with respect to the predetermined event to satisfy the predetermined condition has occurred, as compared with a case where the cause has not occurred. The change tendency is, for example, a change pattern.

The second information may further allow identifying, with respect to a case where a cause for the index value with respect to the predetermined event to satisfy the predetermined condition has not occurred, the change tendency of a statistical value of another index value related to the index value with respect to the predetermined event when the cause has occurred. The change tendency indicates whether a statistical value of another index value related to the index value with respect to the predetermined event has a tendency to increase or a tendency to decrease, for example, when a cause for the index value with respect to the predetermined event to satisfy the predetermined condition has occurred, as compared with the case where the cause has not occurred. The change tendency is, for example, a change pattern. The second information is stored, for example, using the change pattern management tables 1000, 1100, 1200 illustrated in FIGS. 10 to 12. The storage unit 2300 stores, for example, the change pattern management tables 1000, 1100, 1200 illustrated in FIGS. 10 to 12.

The storage unit 2300 stores a result of recognizing a state of a target person using a predetermined sensor. The state of the target person is a position, a movement, a direction, or the like of the target person. The state of the target person corresponds to, for example, a state of the action recording device corresponding to the target person. The predetermined sensor is, for example, the sensors 2204 included in the state detection device 205.

The acquisition unit 2301 acquires various types of information to be used for the processing of each function unit. The acquisition unit 2301 stores the acquired various types of information in the storage unit 2300 or outputs the acquired various types of information to each function unit. Furthermore, the acquisition unit 2301 may output the various types of information stored in the storage unit 2300 to each function unit. The acquisition unit 2301 acquires the various types of information based on, for example, an operating input by the user. The acquisition unit 2301 may receive the various types of information from a device different from the information processing device 100, for example.

The acquisition unit 2301 acquires time-series data of the index value and stores the time-series data in the storage unit 2300. For example, the acquisition unit 2301 acquires the time-series data of the index value by receiving from the index value management device 202 and stores the time-series data in the storage unit 2300.

The acquisition unit 2301 acquires time-series data of an action and stores the time-series data in the storage unit 2300. For example, the acquisition unit 2301 acquires the time-series data of the action by receiving from the information storage device 201 and stores the time-series data in the storage unit 2300.

The acquisition unit 2301 acquires a result of recognizing the state of the target person using a predetermined sensor and stores the result in the storage unit 2300. The acquisition unit 2301 acquires, for example, the result of recognizing the state of the target person using a predetermined sensor from the state detection device 205 and stores the result in the storage unit 2300.

The acquisition unit 2301 accepts, with respect to a case where a cause for the index value with respect to the predetermined event to satisfy the predetermined condition has not occurred, an input of information that allows identifying a change tendency of the amount of an action related to the predetermined event when the cause has occurred. The acquisition unit 2301 accepts, for example, an input of a combination of an action related to the predetermined event, a change tendency of the amount of the action related to the predetermined event, the predetermined event, and the cause. For example, the acquisition unit 2301 accepts an input of a combination of the type of an index value, the type of a related action, a change pattern of the amount of a related action, and a cause. For example, the acquisition unit 2301 accepts an input of a combination of the type of an index value, the type of a related action, a change pattern of the amount of a related action, and a cause from a manager based on a communication content with the manager terminal 203.

The acquisition unit 2301 accepts an input of information that allows identifying the cause of the index value with respect to the predetermined event to satisfy the predetermined condition. The acquisition unit 2301 accepts, for example, an input of the cause as a result of outputting the action related to the predetermined event, the change tendency of the amount of the action related to the predetermined event, and the predetermined event in association with each other. For example, the acquisition unit 2301 accepts an input of a cause to be associated with the type of an index value, the type of a related action, and a change pattern of the amount of a related action. For example, the acquisition unit 2301 accepts an input of a cause to be associated with the type of an index value, the type of a related action, and a change pattern of the amount of a related action from the manager based on the communication content with the manager terminal 203.

The acquisition unit 2301 may accept a start trigger to start processing of any of the function units. The start trigger is, for example, performing a predetermined operating input by the user. The start trigger may be, for example, receiving predetermined information from another computer. The start trigger may be, for example, outputting predetermined information by any of the function units.

For example, the acquisition unit 2301 accepts the performing of the predetermined operating input by the user as the start trigger to start processing of the detection unit 2302, the calculation unit 2304, the identification unit 2305, and the update unit 2306. For example, the acquisition unit 2301 accepts acquiring of the result of recognizing the state of a target person as a start trigger for starting processing by the estimation unit 2303.

The detection unit 2302 detects that the index value with respect to the predetermined event has satisfied the predetermined condition. For example, the detection unit 2302 identifies a predetermined range corresponding to the type of the index value with respect to the predetermined event based on the index value threshold management table 600, and detects that the index value with respect to the predetermined event is out of the identified predetermined range.

For example, the detection unit 2302 identifies the predetermined condition corresponding to the type of the index value with respect to the predetermined event based on the condition management table 700, and detects that the index value with respect to the predetermined event has satisfied the identified predetermined condition. For example, the detection unit 2302 detects that the target person identified by the index value is other than the specific target person. For example, the detection unit 2302 detects that the target person identified by the index value is not a doctor or a nurse but a clerk. Thus, the detection unit 2302 may detect that a problem has occurred in the operation.

The estimation unit 2303 generates the first information based on the result of recognizing the state of the target person using a predetermined sensor. For example, the estimation unit 2303 estimates an action of the target person based on the result of recognizing the state of the target person using the predetermined sensor, and generates the first information. For example, the estimation unit 2303 estimates an action associated with the recognized position of the target person among actions associated with every position in advance as the action of the target person, and generates the first information. Thus, the estimation unit 2303 may avoid acquiring information indicating the action of the target person from the action recording terminal 204.

The estimation unit 2303 groups a plurality of actions based on a name that identifies each of the plurality of actions. The estimation unit 2303 calculates a similarity for every pair of action names, for example. The similarity is, for example, Word2Vec. The estimation unit 2303 identifies, for example, a pair of action names whose calculated similarity exceeds a threshold as a pair of similar action names based on the similarity threshold management table 900. The estimation unit 2303 classifies, for example, a pair of actions corresponding to the pair of similar action names into the same group. Thus, the estimation unit 2303 may identify a pair of actions for which it is preferable to handle the amount of action collectively.

Based on the first information, the calculation unit 2304 acquires the amount of an action related to the predetermined event in a time zone corresponding to a time point when the index value with respect to the predetermined event has satisfied the predetermined condition. The time zone is, for example, a time point when the index value with respect to the predetermined event has satisfied the predetermined condition. The time zone is, for example, a time width of a predetermined length including the time point when the index value with respect to the predetermined event has satisfied the predetermined condition.

For example, the calculation unit 2304 identifies an action related to the predetermined event associated with the index value with respect to the predetermined event based on the change pattern management table 1000. Based on the search width management table 1300, the calculation unit 2304 identifies, for example, the time zone from a time point of the search width (before) to a time point of the search width (after) on the basis of the time point when the index value with respect to the predetermined event has satisfied the predetermined condition. The calculation unit 2304 acquires, for example, the amount of the identified action in the identified time zone by calculation based on the action management table 500. Thus, the calculation unit 2304 may obtain information useful for identifying a cause of the problem.

Based on the first information, the calculation unit 2304 calculates the amount of each of a plurality of actions related to the predetermined event in the time zone corresponding to a time point when the index value with respect to the predetermined event has satisfied the predetermined condition. The calculation unit 2304 identifies, for example, a plurality of actions related to the predetermined event, which is associated with the index value with respect to the predetermined event, based on the change pattern management table 1100. Based on the search width management table 1300, the calculation unit 2304 identifies, for example, the time zone from a time point of the search width (before) to a time point of the search width (after) on the basis of the time point when the index value with respect to the predetermined event has satisfied the predetermined condition. The calculation unit 2304 acquires, for example, the amount of each of the plurality of identified actions in the identified time zone by calculation based on the action management table 500. Thus, the calculation unit 2304 may obtain information useful for identifying a cause of the problem.

Based on the first information, the calculation unit 2304 calculates a statistic based on an amount of each of one or more actions belonging to the group including actions related to the predetermined event in the time zone corresponding to the time point when the index value with respect to the predetermined event has satisfied the predetermined condition. For example, the calculation unit 2304 identifies an action related to the predetermined event associated with the index value with respect to the predetermined event based on the change pattern management tables 1000, 1100, 1200. The calculation unit 2304 identifies, for example, one or more actions belonging to a group including the identified action. Based on the search width management table 1300, the calculation unit 2304 identifies, for example, the time zone from a time point of the search width (before) to a time point of the search width (after) on the basis of the time point when the index value with respect to the predetermined event has satisfied the predetermined condition. The calculation unit 2304 acquires, for example, the amount of each of one or more identified actions in the identified time zone by calculation based on the action management table 500. Thus, the calculation unit 2304 may obtain information useful for identifying a cause of the problem.

The calculation unit 2304 acquires a statistical value of another index value related to an index value with respect to the predetermined event in the time zone corresponding to the time point when the index value with respect to the predetermined event has satisfied the predetermined condition. The statistical value is, for example, total, maximum, minimum, mean, mode, median, variance, standard deviation, or the like. The calculation unit 2304 identifies, for example, another index value related to the index value with respect to the predetermined event based on the change pattern management table 1200. Based on the search width management table 1300, the calculation unit 2304 identifies, for example, the time zone from a time point of the search width (before) to a time point of the search width (after) on the basis of the time point when the index value with respect to the predetermined event has satisfied the predetermined condition. The calculation unit 2304 acquires, for example, the statistical value of another identified index value in the identified time zone by calculation based on the index value management table 400. Thus, the calculation unit 2304 may obtain information useful for identifying a cause of the problem.

The Identification unit 2305 compares the amount of an action related to the predetermined event in the time zone corresponding to the time point when the acquired index value with respect to the predetermined event has satisfied the predetermined condition, with the amount of an action related to the predetermined event in a past time zone. The past time zone is, for example, a normal time. Then, the identification unit 2305 identifies a cause corresponding to a comparison result based on the second information.

The identification unit 2305 acquires the amount of a related action in a normal time zone based on, for example, the normal time-related action amount management table 1500. The identification unit 2305 compares, for example, the amount of a related action related to the predetermined event in the time zone corresponding to the time point when the index value with respect to the predetermined event has satisfied the predetermined condition, with the amount of a related action in the normal time zone. As a result of comparison, the identification unit 2305 identifies what kind of change pattern there is, for example, in the amount of a related action related to the predetermined event in the time zone corresponding to the time point when the index value with respect to the predetermined event has satisfied the predetermined condition as compared with the normal time zone. The change pattern is an increasing tendency, a decreasing tendency, a tendency not to increase or decrease, or the like. Thus, the identification unit 2305 may obtain information useful for identifying a cause of the problem.

Based on the change pattern management table 1000, the identification unit 2305 identifies a cause associated with the combination of the type of an index value, the type of a related action, and the change pattern identified as a result of comparison. Thus, the identification unit 2305 may identify this time a cause that the index value with respect to the predetermined event has satisfied the predetermined condition.

The identification unit 2305 compares respective amounts of a plurality of actions related to the predetermined event in the time zone corresponding to the time point when the acquired index value with respect to the predetermined event has satisfied the predetermined condition, with respective amounts of a plurality of actions related to the predetermined event in the past time zone. The identification unit 2305 identifies a cause corresponding to a comparison result based on the second information.

The Identification unit 2305 acquires, for example, respective amounts of a plurality of related actions in the normal time zone based on the normal time-related action amount management table 1500. The identification unit 2305 compares, for example, respective amounts of a plurality of related actions related to the predetermined event in the time zone corresponding to the time point when the index value with respect to the predetermined event has satisfied the predetermined condition, with respective amounts of a plurality of related actions in the normal time zone. As a result of comparison, the identification unit 2305 identifies what kind of change pattern there is, for example, in the respective amounts of a plurality of related actions related to the predetermined event in the time zone corresponding to the time point when the index value with respect to the predetermined event has satisfied the predetermined condition as compared with the normal time zone. The change pattern is an increasing tendency, a decreasing tendency, a tendency not to increase or decrease, or the like. Thus, the identification unit 2305 may obtain information useful for identifying a cause of the problem.

Based on the change pattern management table 1100, the identification unit 2305 identifies a cause associated with the combination of the type of an index value, the respective types of a plurality of related actions, and the change pattern identified as a result of comparison. Thus, the identification unit 2305 may identify this time a cause that the index value with respect to the predetermined event has satisfied the predetermined condition.

The Identification unit 2305 compares the amount of an action related to the predetermined event in the time zone corresponding to the time point when the index value with respect to the predetermined event has satisfied the predetermined condition, with the amount of an action related to the predetermined event in the past time zone. Furthermore, the identification unit 2305 compares a statistical value of another index value related to the index value with respect to the predetermined event in the time zone corresponding to the time point when the index value with respect to the predetermined event has satisfied the predetermined condition, with a statistical value of another index value related to the index value with respect to the predetermined event in the past time zone. Then, the identification unit 2305 identifies a cause corresponding to a comparison result based on the second information.

The identification unit 2305 acquires, for example, the amount of a related action in the normal time zone and a statistical value of another index value related to an index value with respect to the predetermined event based on the normal time-related action amount management table 1500. The identification unit 2305 compares, for example, the amount of a related action related to the predetermined event in the time zone corresponding to the time point when the index value with respect to the predetermined event has satisfied the predetermined condition, with the amount of a related action in the normal time zone. The identification unit 2305 compares, for example, a statistical value of another index value related to the index value with respect to the predetermined event in the time zone corresponding to the time point when the index value with respect to the predetermined event has satisfied the predetermined condition, with a statistical value of another index value related to the index value with respect to the predetermined event in the normal time zone.

As a result of comparison, the identification unit 2305 identifies what kind of change pattern there is, for example, in the amount of a related action related to the predetermined event in the time zone corresponding to the time point when the index value with respect to the predetermined event has satisfied the predetermined condition as compared with the normal time zone. Furthermore, as a result of comparison, the identification unit 2305 identifies what kind of change pattern is in, for example, a statistical value of another index value related to the index value with respect to the predetermined event in the time zone corresponding to the time point when the index value with respect to the predetermined event has satisfied the predetermined condition as compared with the normal time zone. Thus, the identification unit 2305 may obtain information useful for identifying a cause of the problem.

Based on the change pattern management table 1200, the identification unit 2305 identifies a cause associated with the combination of the type of an index value with respect to the predetermined event, the type of a related action, the type of another index value related to the index value with respect to the predetermined event, and the identified change pattern. Thus, the identification unit 2305 may identify this time a cause that the index value with respect to the predetermined event has satisfied the predetermined condition.

The Identification unit 2305 compares the acquired statistic with a statistic based on an amount of each of one or more actions belonging to a group including actions related to the predetermined event in the past time zone. Then, the identification unit 2305 identifies a cause corresponding to a comparison result based on the second information.

The identification unit 2305 calculates, for example, a statistic based on an amount of each of one or more actions belonging to a group including actions related to the predetermined event in the normal time zone based on the normal time-related action amount management table 1500. The identification unit 2305 compares, for example, the acquired statistic with the calculated statistic. As a result of comparison, the identification unit 2305 identifies what kind of change pattern there is, for example, in the statistic in the time zone corresponding to the time point when the index value with respect to the predetermined event has satisfied the predetermined condition as compared with the normal time zone. The change pattern is an increasing tendency, a decreasing tendency, a tendency not to increase or decrease, or the like. Thus, the identification unit 2305 may obtain information useful for identifying a cause of the problem.

The identification unit 2305 employs the change pattern of the statistic as the change pattern of the related action. Based on the change pattern management table 1000, the identification unit 2305 identifies a cause associated with the combination of the type of an index value, the type of a related action, and the change pattern identified as a result of comparison. Thus, the identification unit 2305 may identify this time a cause that the index value with respect to the predetermined event has satisfied the predetermined condition.

The update unit 2306 updates, with respect to a case where a cause for the index value with respect to the predetermined event to satisfy the predetermined condition has not occurred, the second information based on input information that allows identifying a change tendency of the amount of an action related to the predetermined event when the cause has occurred. The update unit 2306 updates the second information based on, for example, a combination of an action related to the predetermined event, a change tendency of the amount of an action related to the predetermined event, the predetermined event, and a cause which are input. For example, the update unit 2306 updates the change pattern management tables 1000, 1100, 1200 based on a combination of the type of an index value, the type of a related action, the change pattern in the amount of a related action, and the cause which are input. Thus, the update unit 2306 may update the second information and improve the accuracy of identifying the cause of the problem in the operation.

The update unit 2306 updates the second information based on the input information that allows identifying the cause for the index value with respect to the predetermined event to satisfy the predetermined condition. The update unit 2306 updates the second information based on, for example, a combination of an action related to the predetermined event, a change tendency of the amount of an action related to the predetermined event, the predetermined event, and the input cause. For example, the update unit 2306 updates the change pattern management tables 1000, 1100, 1200 based on a combination of the type of an index value, the type of a related action, the change pattern in the amount of a related action, and the input cause. Thus, the update unit 2306 may update the second information and improve the accuracy of identifying the cause of the problem in the operation. In addition, the update unit 2306 may be able to update the second information if a manager inputs the cause, and may reduce a work load on the manager.

The output unit 2307 outputs a processing result of any of the function units. An output format is, for example, display on a display, print output to a printer, transmission to an external device by the network I/F 303, or storage to the storage area of the memory 302, the recording medium 305, or the like. Thus, the output unit 2307 makes it possible to notify the user of the processing result of any of the function units, and may improve convenience of the information processing device 100.

The output unit 2307 displays actions performed by a target person at each of the plurality of time points along the time axis. If the identified cause is an action performed by the target person at any of a plurality of time points, the output unit 2307 displays at least one of the target person, the identified action to be the cause, or the action related to the predetermined event on the displayed time axis in a specific display mode. A particular display mode is, for example, a highlight.

For example, the output unit 2307 causes the display 2006 of the manager terminal 203 to display a screen illustrating an action performed by the target person at each of the plurality of time points along the time axis. For example, when causing the display 2006 of the manager terminal 203 to display the screen, the output unit 2307 causes at least one of the target person, the identified action to be the cause, or the action related to the predetermined event on the time axis to be displayed in a specific display mode. Thus, the output unit 2307 may make it easy for the manager to grasp the target person, the identified action to be the cause, and the action related to the predetermined event.

The output unit 2307 displays actions performed by a target person at each of the plurality of time points along the time axis. The output unit 2307 displays a message indicating the identified cause together with the time axis. For example, the output unit 2307 causes the display 2006 of the manager terminal 203 to display a screen illustrating an action performed by the target person at each of the plurality of time points along the time axis. For example, when causing the display 2006 of the manager terminal 203 to display the screen, the output unit 2307 causes a message indicating the identified cause to be displayed together with the time axis. Thus, the output unit 2307 may make it easy to for the manager to grasp the identified cause. Furthermore, the output unit 2307 may be applied to a situation where it is difficult to display the identified cause on the time axis.

As a result of comparison, the output unit 2307 determines whether or not the difference between the amount of an action related to the predetermined event in the time zone corresponding to the time point when the index value with respect to the predetermined event has satisfied the predetermined condition, and the amount of an action related to the predetermined event in the past time zone is equal to or less than a threshold. When it is equal to or less than the threshold, the output unit 2307 associates and outputs the action related to the predetermined event, the change tendency of the amount of an action related to the predetermined event in the time zone corresponding to the time point when the index value with respect to the predetermined event has satisfied the predetermined condition for the past time zone, and the predetermined event. Thus, the output unit 2307 may output useful information when estimating a cause of the problem in the operation so that the manager is able to refer to the information.

(One Example of Operation of Information Processing Device 100)

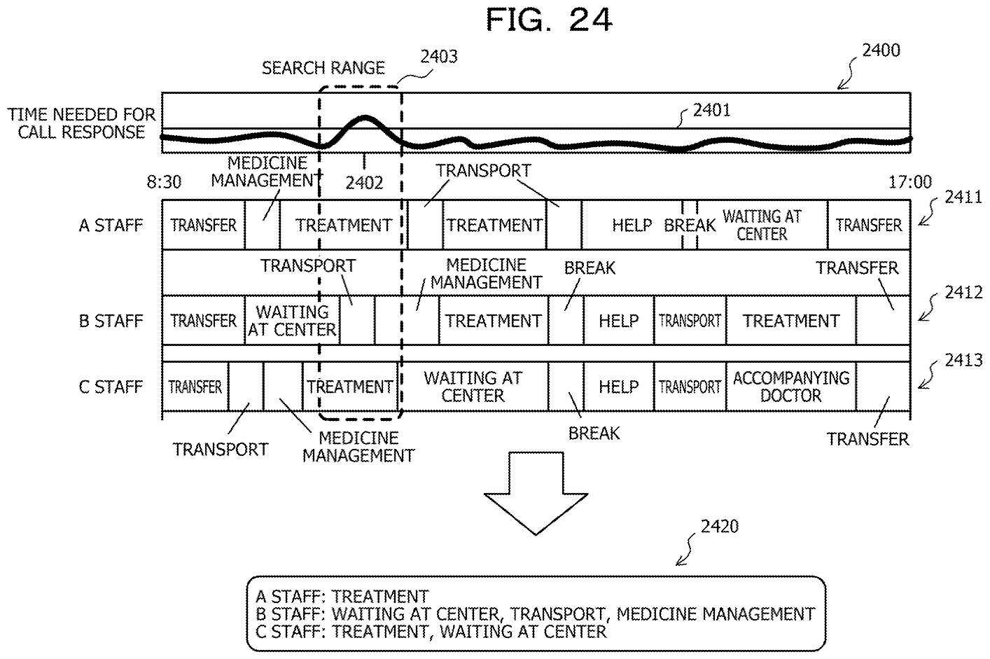

Next, an example of operation of the information processing device 100 will be described with reference to FIGS. 24 to 26.

FIG. 24 to 26 is an explanatory diagram illustrating an example of operation of the information processing device 100. In FIG. 24, it is assumed that the information processing device 100 is applied to the medical field. It is assumed that the index value is a time needed for responding to a nurse call. It is assumed that target persons are A staff, B staff, and C staff.

The information processing device 100 acquires time-series data of the index value illustrated in a graph 2400. In the graph 2400, a straight line 2401 indicates the threshold lower limit stored in the index value threshold management table 600, and indicates the predetermined condition for determining that a problem has occurred in the operation. For simplicity of description, it is assumed that there is no threshold upper limit. The information processing device 100 acquires time-series data of actions of the A staff illustrated in a graph 2411, time-series data of actions of the B staff illustrated in a graph 2412, and time-series data of actions of the C staff illustrated in a graph 2413.

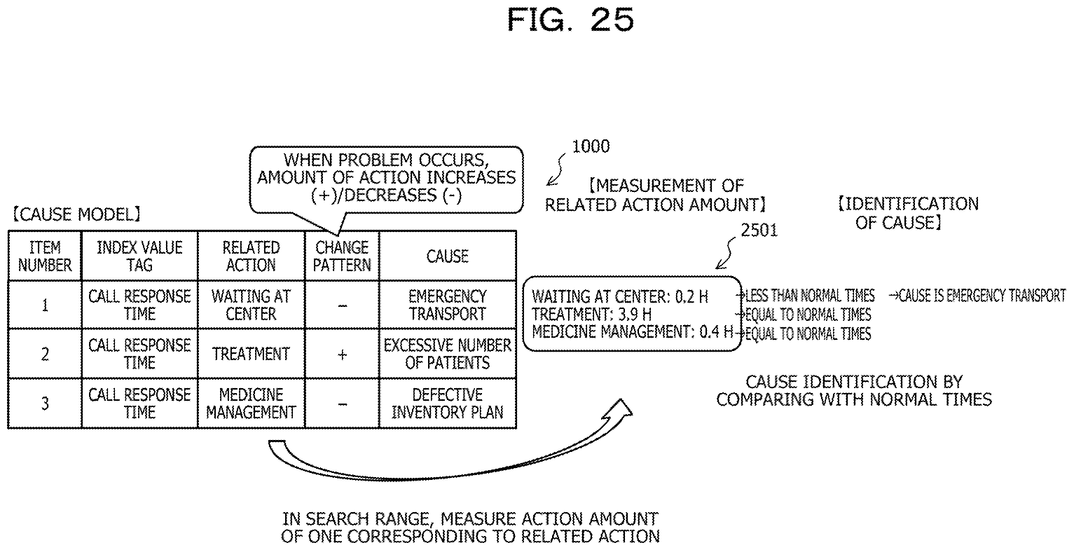

The information processing device 100 detects that the index value exceeds the threshold lower limit at a time point 2402 based on the time-series data of the index value. The information processing device 100 sets the time point 2402 as a problem occurrence time point. The information processing device 100 sets a search range 2403 on the basis of the problem occurrence time point based on the search width management table 1300. The information processing device 100 identifies the action of the A staff, the action of the B staff, and the action of the C staff in the set search range 2403, and acquires a list of actions 2420 for every target person. Next, description of FIG. 25 will be made.

In FIG. 25, the information processing device 100 acquires the change pattern management table 1000. The information processing device 100 identifies a related action associated with the type of the index value in the change pattern management table 1000. The information processing device 100 calculates the amount of the specified related action based on the list of actions 2420 for every target person, and acquires a list 2501 of the amount of a related action. In the example of FIG. 25, the amount of a related action is a sum of times during which related actions have been performed. The information processing device 100 calculates, for example, the amount of 0.2 H of a related action of waiting at the center, the amount of 3.9 H of a related action of treatment, and the amount of 0.4 H of a related action of medicine management.

The information processing device 100 acquires the amount of the identified related action in normal times based on the normal time-related action amount management table 1500. The information processing device 100 compares the calculated amount of a related action with the acquired amount of a related action for every related action. In the example of FIG. 25, the information processing device 100 identifies that the amount of a related action of waiting at the center tends to decrease as compared with normal times.

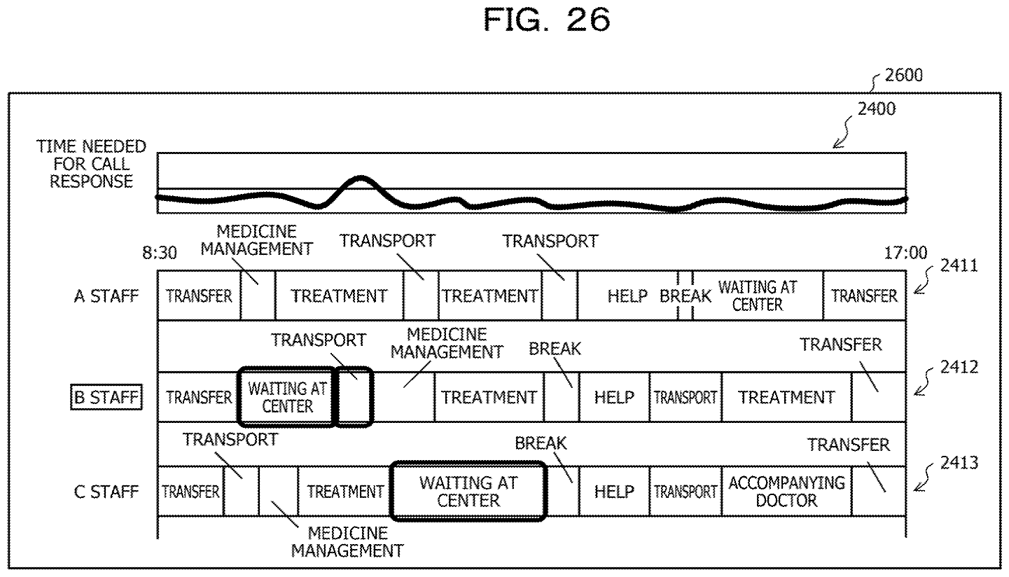

The information processing device 100 identifies a cause corresponding to a comparison result based on the change pattern management table 1000. In the example of FIG. 25, since the information processing device 100 has a tendency to decrease in the amount of a related action such as waiting at the center as compared with normal times, emergency transport is identified as the cause. Thus, the information processing device 100 may identify the cause of the problem. Next, description of FIG. 26 will be made.

In FIG. 26, the information processing device 100 generates a screen 2600 that includes the graph 2400, the graph 2411 associated with the name of the A staff, the graph 2412 associated with the name of the B staff, and the graph 2413 associated with the name of the C staff. On screen 2600, the related action “waiting at center” that has become an index when identifying the cause “emergency transport”, the action “transport” that has become the cause “emergency transport”, and the target person “B staff” who has performed the action “transport” are displayed in a specific display mode. The specific display mode is, for example, a highlight display. The specific display mode is, for example, a mode surrounded by a rectangle. The information processing device 100 transmits a display request for the screen 2600 to the manager terminal 203 to thereby cause display of the screen 2600 on the manager terminal 203.

Thus, the information processing device 100 may enable the manager to grasp a direct or superficial reason why the problem has occurred in the operation directly or superficially by referring to the related action “waiting at center” that has become an index when the manager identifies the cause “emergency transport”. Furthermore, the information processing device 100 may enable the manager to grasp an indirect or potential cause that the problem has occurred in the operation by referring to the action “transport” that has become the cause “emergency transport”, and the target person “B staff” who has performed the action “transport”. Therefore, the information processing device 100 may reduce the work load, the work time, the mental burden, and the like on the manager.

Here, the case where the information processing device 100 identifies the cause based on the amount of one type of action by referring to the change pattern management table 1000 has been described, but the present embodiment is not limited to this. For example, there may be cases where the information processing device 100 identifies the cause based on the amounts of a plurality of types of actions by referring to the change pattern management table 1100. Furthermore, for example, there may be cases where the information processing device 100 identifies the cause, by referring to the change pattern management table 1200, based on the amount of an action and the statistical value of an index value other than the index value with which an occurrence of a problem has been detected.

For example, the change pattern management tables 1000, 1100, 1200 may be manually created in advance. For example, the change pattern management tables 1000, 1100, 1200 may be manually created in advance and then updated by the manager.

In addition, for example, the change pattern management tables 1000, 1100, 1200 may be manually created in advance and then automatically updated by the information processing device 100. Furthermore, for example, the change pattern management tables 1000, 1100, 1200 may be automatically created by the information processing device 100 and then automatically updated by the information processing device 100.

The information processing device 100 compares, for example, the amount of an action in normal times with the amount of an action in the time zone in which the problem has occurred and, based on a difference in the amounts of actions, updates the change pattern management tables 1000, 1100, 1200 automatically.

(Another Example of Screen to be Displayed)

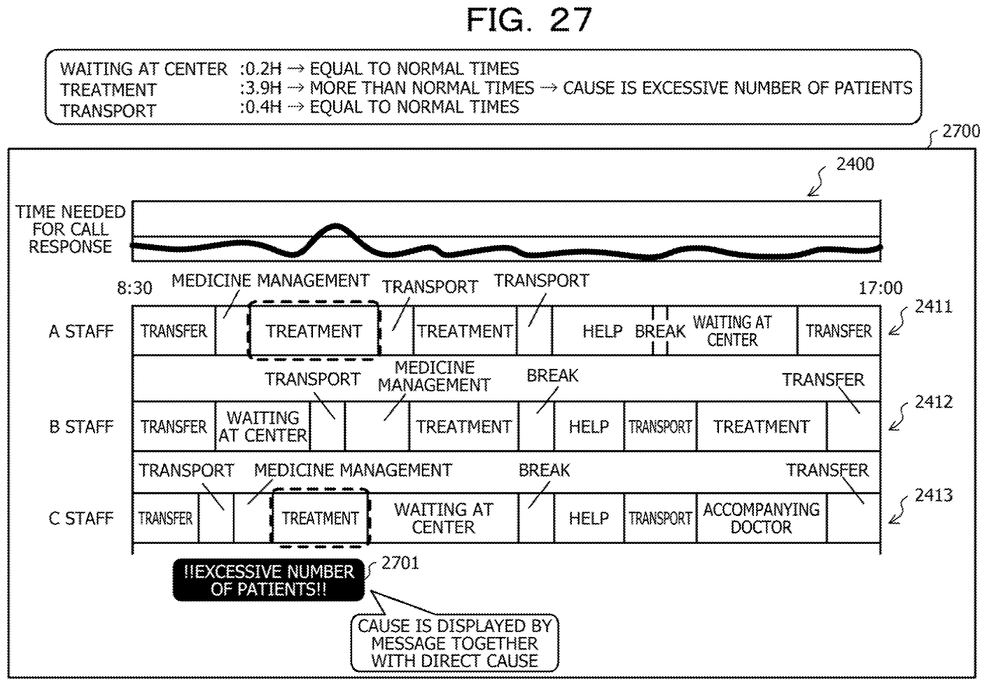

Next, another example of the screen that the information processing device 100 causes the manager terminal 203 to display will be described with reference to FIG. 27.

FIG. 27 is an explanatory diagram illustrating another example of the screen to be displayed. In the example of FIG. 27, it is assumed that the information processing device 100 is identified as the cause of an excessive number of patients because the amount of a related action such as treatment tends to increase as compared with normal times.

In FIG. 27, the information processing device 100 generates a screen 2700 that includes the graph 2400, the graph 2411 associated with the name of the A staff, the graph 2412 associated with the name of the B staff, and the graph 2413 associated with the name of the C staff. On the screen 2700, a message “!!Excessive number of patients!!” indicating the cause “excessive number of patients” with the reference numeral 2701 is displayed together with the graphs 2411 to 2413. On the screen 2700, the related action “treatment” that has become an index when identifying the cause “excessive number of patients”, is displayed in a specific display mode. The information processing device 100 transmits a display request of the screen 2700 to the manager terminal 203 to thereby cause display of the screen 2700 on the manager terminal 203.

Thus, the information processing device 100 may include a message indicating the cause on the screen 2700 even in a situation where the action of the target person is not a cause of the problem in the operation. The information processing device 100 may enable the manager to grasp a direct or superficial reason why the problem has occurred in the operation by referring to the related action “treatment” that has become an index when the manager identifies the cause “excessive number of patients”. Furthermore, the information processing device 100 may enable the manager to grasp the indirect or potential cause of the problem in the operation by referring to a message. Therefore, the information processing device 100 may reduce the work load, the work time, the mental burden, and the like on the manager.

In the examples of FIGS. 24 to 26, the case where the information processing device 100 handles the amount of a related action in the related action unit has been described, but the present embodiment is not limited to this. For example, the information processing device 100 may group actions and collectively treat the amounts of a plurality of actions belonging to the group including related actions as the amount of a related action.

(Example of Grouping Actions)

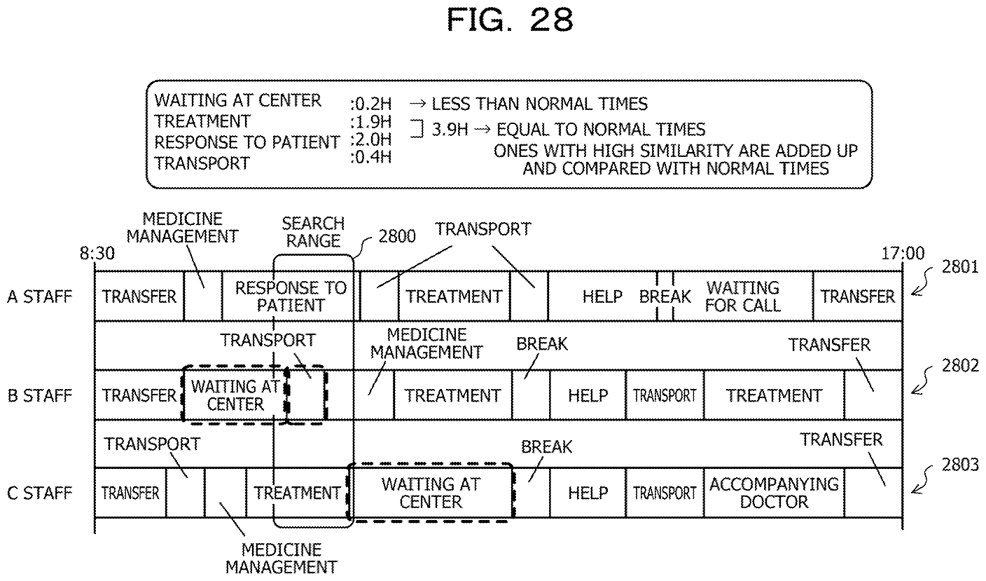

Next, an example in which the information processing device 100 groups actions will be described with reference to FIG. 28.

FIG. 28 is an explanatory diagram illustrating an example of grouping actions. In FIG. 28, the information processing device 100 uses Word2Vec to calculate similarities of action name pairs. The information processing device 100 groups a plurality of actions so that the pair of actions corresponding to the pair of action names whose similarity exceeds the threshold belongs to the same group based on the similarity threshold management table 900. In the example of FIG. 28, it is assumed that the information processing device 100 classifies a pair of actions of treatment and response to patient into the same group. The information processing device 100 independently classifies the action of waiting at the center into one group, and independently classifies the action of transport into one group.

Thereafter, the information processing device 100 sets a search range 2800 on the basis of a problem occurrence time point. The action of A staff is illustrated in a graph 2801. The action of B staff is illustrated in a graph 2802. The action of C staff is illustrated in a graph 2803. In calculating the amount of a related action in the search range 2800, the information processing device 100 calculates statistics of the amounts of the plurality of actions belonging to the group including related actions as the amounts of related actions. In the example of FIG. 28, the information processing device 100 calculates, for example, for every group, the amount of 0.2 H of the related action of waiting at the center, the sum of 3.9 H of the amount of the related action of treatment and the amount of the related action of response to patient, and the amount of 0.4 H of the related action of transport.

The information processing device 100 acquires the amount of a related action in normal times based on the normal time-related action amount management table 1500. The information processing device 100 compares the calculated statistic of the amount of a related action with the statistic of the acquired amount of related actions for every group. In the example of FIG. 28, the information processing device 100 identifies that the amount of the related action of waiting at the center tends to decrease as compared with normal times.

The information processing device 100 identifies a cause corresponding to a comparison result based on the change pattern management table 1000. In the example of FIG. 28, because the amount of the related action of waiting at the center tends to decrease as compared with normal times, the information processing device 100 identifies emergency transport as the cause. Thus, the information processing device 100 may identify the cause of the problem. The information processing device 100 may group actions to improve accuracy of identifying the cause of the problem.

(First Specific Example of Operation of Information Processing Device 100)

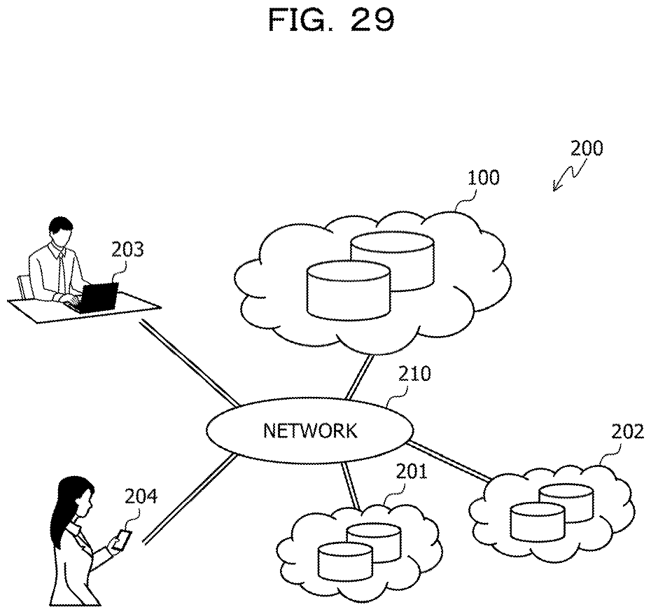

Next, a first specific example of operation of the information processing device 100 will be described with reference to FIGS. 29 to 32. The first specific example corresponds to a case where the information processing device 100 collects process data indicating actions of target persons from the action recording terminal 204 and acquires time-series data of the actions.

First, a configuration example of the information processing system 200 in the first specific example will be described with reference to FIG. 29.

FIG. 29 is an explanatory diagram illustrating a configuration example of the information processing system 200 in the first specific example. In the first specific example, the information processing system 200 includes the information processing device 100, the information storage device 201, the index value management device 202, the manager terminal 203, and the action recording terminal 204. Here, the information processing device 100 may be implemented on the cloud. The information storage device 201 may be implemented on the cloud. The index value management device 202 may be implemented on the cloud.

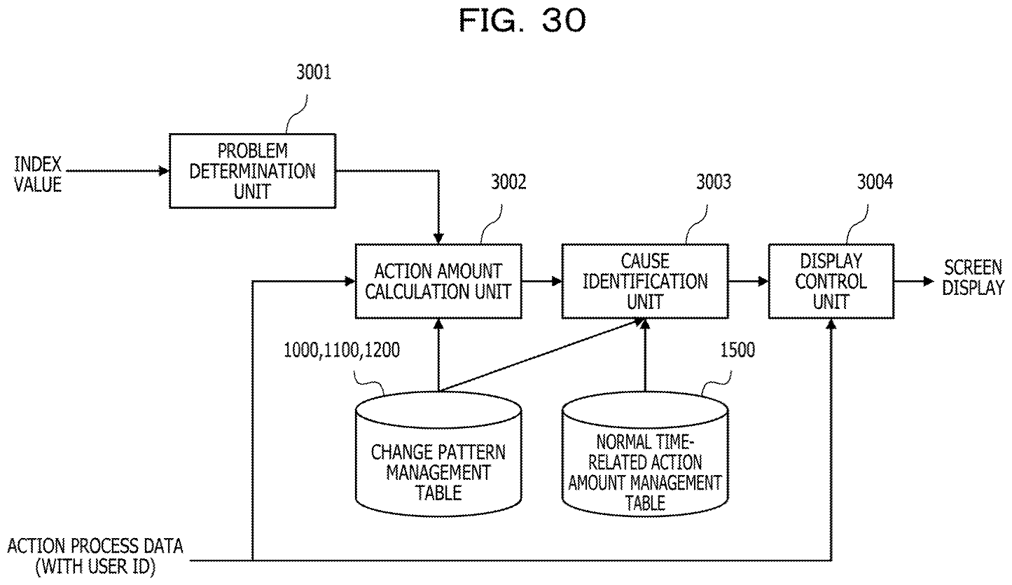

Next, a specific example of a functional configuration of the information processing device 100 in the first specific example will be described with reference to FIG. 30.

FIG. 30 is an explanatory diagram illustrating a specific example of the functional configuration of the information processing device 100 in the first specific example. In FIG. 30, the information processing device 100 indudes a problem determination unit 3001, an action amount calculation unit 3002, a cause identification unit 3003, and a display control unit 3004. The information processing device 100 has a change pattern management table 1000 and a normal time-related action amount management table 1500.

The information processing device 100 acquires one or more pieces of process data associated with the user ID, and acquires one or more pieces of time-series data of an action based on the one or more pieces of process data. The information processing device 100 acquires one or more pieces of time-series data of an index value.

The problem determination unit 3001 determines whether or not a problem is present at each time point based on the index value, and identifies a problem occurrence time point. The action amount calculation unit 3002 identifies a predetermined time zone including a before and after time on the basis of the problem occurrence time point as a problem occurrence time and, based on the time-series data of the action, extracts an action corresponding to a related action in the problem occurrence time and calculates the amount of a related action. The cause identification unit 3003 compares the amount of a related action in normal times with the amount of a related action in the problem occurrence time, and identifies a cause corresponding to a comparison result based on the change pattern management table 1000. The display control unit 3004 displays the related action and the cause on the manager terminal 203 in association with the time-series data of the action.

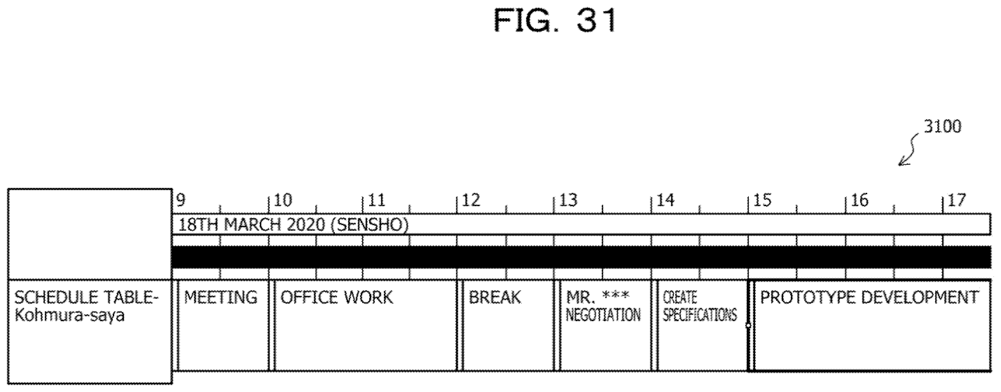

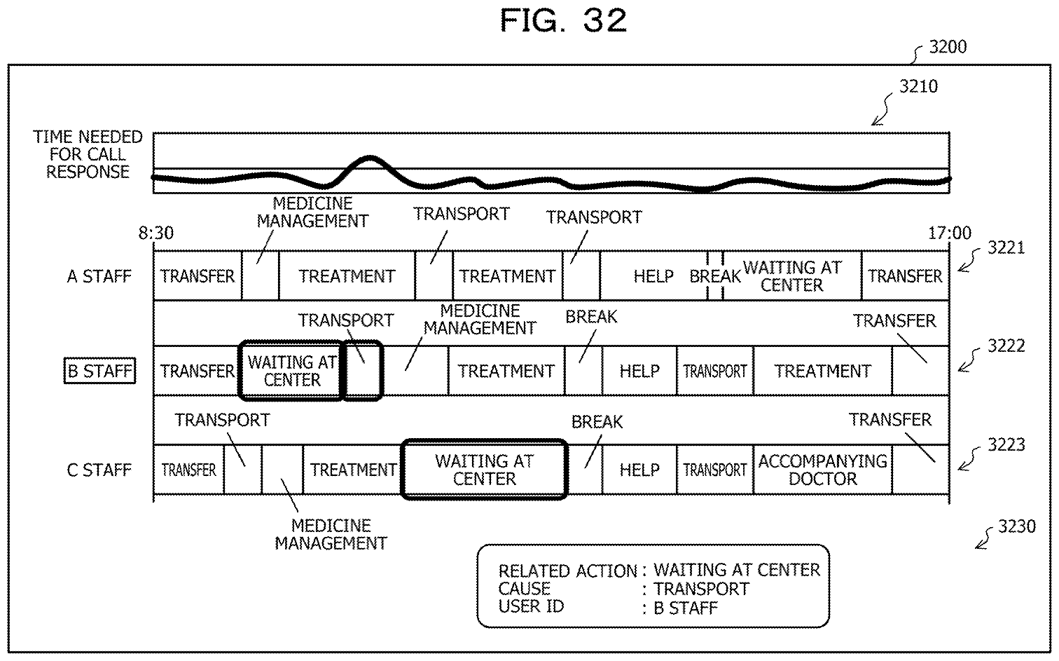

Next, the first specific example of operation of the information processing device 100 will be described with reference to FIGS. 31 and 32.

FIGS. 31 and 32 are explanatory diagrams illustrating the first specific example of operation of the information processing device 100. In FIG. 31, the information processing device 100 acquires an action schedule illustrated in Table 3100, which is associated with the user ID, as process data from the action recording terminal 204. The information processing device 100 acquires a combination of the user ID=u, an action start time point Ds_u(i), an action end time point De_u(i), and an action name A_u(i) based on the action schedule, and stores them in the action management table 500. At this time, the information processing device 100 may further associate the location where the action has been performed, the user ID of any other target person who has performed the action together, and the like and store them in the action management table 500.

The information processing device 100 acquires an index value I_x(t) from the index value management device 202. It is assumed that the index value management device 202 is included in an existing operation system and calculates the index value I_x(t), for example. In the following description, it is assumed that the index value I_1(t) is a response time to a nurse call in a medical ward.

The index value I_x(t) may be, for example, a production quantity, the number of defective products, a yield, the number of accidents, or the like, as long as it is a value related to the manufacturing industry. The index value I_x(t) may be, for example, an average processing time, a talk time, a post-processing time, a response rate, an average response speed, or the like, as long as it is a value related to a call center.

The problem determination unit 3001 monitors I_x(t), and sets a time point when the threshold TH1 is exceeded as a problem occurrence time point T. The threshold TH1 is identified with, for example, the index value threshold management table 600. For example, if I_x(t)>TH1, the problem determination unit 3001 sets the problem occurrence time point T←t.

At this time, the problem determination unit 3001 is configured not to update the problem occurrence time point T until I_x(t) becomes equal to or lower than a certain value for a certain time after I_x(t)>TH1 once. For example, the problem determination unit 3001 does not update the problem occurrence time point T until I_x(t)<TH1 continues for 5 minutes.

Furthermore, the problem determination unit 3001 may be configured not to update the problem occurrence time point T until a certain time elapses after I_x(t)>TH1 once. Thus, the problem determination unit 3001 may avoid repeating changes of the problem occurrence time point T in a short period of time, and may avoid deterioration of operation stability of the information processing device 100.

The problem determination unit 3001 monitors I_x(t), and a time point when it falls below the threshold TH1 may be set as the problem occurrence time point T. The threshold TH1 is identified with, for example, the index value threshold management table 600. For example, if I_x(t)<TH1, the problem determination unit 3001 sets the problem occurrence time point T←t.

At this time, the problem determination unit 3001 is configured not to update the problem occurrence time point T until I_x(t) becomes equal to or higher than a certain value for a certain time after I_x(t)<TH1. The problem determination unit 3001 does not update the problem occurrence time point T until, for example, I_x(t)>TH1 continues for 5 minutes.

Furthermore, the problem determination unit 3001 may be configured not to update the problem occurrence time point T until a certain time elapses after I_x(t)<TH1 once. Thus, the problem determination unit 3001 may avoid repeating changes of the problem occurrence time point T in a short period of time, and may avoid deterioration of operation stability of the information processing device 100.

The problem determination unit 3001 monitors I_x(t), and a time point when I_x(t) exceeds the range between the threshold upper limit TH₋ and the threshold lower limit TH₊ may be set as the problem occurrence time point T. The threshold upper limit TH₋ and the threshold lower limit TH₊ are identified with, for example, the index value threshold management table 600. For example, if I_x(t)<TH₋ or I_x(t)<TH₊, the problem determination unit 3001 sets the problem occurrence time point T←t.

At this time, the problem determination unit 3001 is configured not to update the problem occurrence time point T until I_x(t) continues to be within the range for a certain time after exceeding the range once. For example, the problem determination unit 3001 does not update the problem occurrence time point T until TH₋≤I_x(t)≤TH₊ continues for 30 seconds.

Furthermore, the problem determination unit 3001 may be configured not to update the problem occurrence time point T until a certain time elapses after the range is exceeded once. Thus, the problem determination unit 3001 may avoid repeating changes of the problem occurrence time point T in a short period of time, and may avoid deterioration of operation stability of the information processing device 100.

The problem determination unit 3001 may use machine learning to identify the problem occurrence time point T when a problem has occurred in the operation. The problem determination unit 3001 identifies the problem occurrence time point T by using, for example, an abnormal value detection method of time-series data. For example, the problem determination unit 3001 uses a k-nearest neighbor method to determine that a problem has occurred in the operation and identifies the problem occurrence time point T when the index value is separated from the average value of k neighboring index values by a certain amount or more. For example, the problem determination unit 3001 prepares a prediction model of the index value in advance, and determines that a problem has occurred in the operation and identifies the problem occurrence time point T when the difference between an index value predicted by the prediction model and the actual index value is equal to or more than a certain value.

The problem determination unit 3001 identifies the problem occurrence time point T by using, for example, SVM. For example, the problem determination unit 3001 prepares a learning data set in which the index value and a tag of whether or not there is a problem are associated with each other, and identifies a classification boundary by using C-Support Vector Classification. Then, the problem determination unit 3001 determines whether or not a problem has occurred in the operation according to the identified classification boundary, and identifies the problem occurrence time point T. The problem determination unit 3001 may determine whether or not a problem has occurred in the operation based on a combination of a plurality of index values I_x(t).

In the change pattern management table 1000, with an item number j and an action number k, an index value tag M_I(j)=index value number x, a related action M_A(j, k), a change pattern M_P(j, k) of the related action, and a cause M_C(j) are associated and stored. The change pattern management table 1000 may be updated sequentially.

The action amount calculation unit 3002 calculates a cosine similarity between action names A_u(i) with each other using Word2Vec and sets an action similarity s. The action amount calculation unit 3002 determines whether or not the action similarity s is larger than the similarity determination threshold TH2. The action amount calculation unit 3002 groups action names A_u(i) whose action similarity s is larger than the similarity determination threshold TH2 as similar action names. The action amount calculation unit 3002 stores a grouping result in the group management table 800. The similarity determination threshold TH2 is identified by, for example, the similarity threshold management table 900 for similarity. For example, TH2=0.8.

The action amount calculation unit 3002 sets a search time range T−Ta_x to T+Tb_x on the basis of the problem occurrence time point T by referring to the search width management table 1300. For example, Ta_1=20 minutes corresponding to the index value number 1 and Tb_1=0 minutes corresponding to the index value number 1. Ta_x and Tb_x are set in advance, for example, according to characteristics of the index value.

The action amount calculation unit 3002 searches for A_u(i) that matches M_A(j, k) in the search time range. The action amount calculation unit 3002 calculates a normalized amount Q(j, k) of a related action if there is A_u(i) that matches M_A(j, k). At this time, the action amount calculation unit 3002 decides to add up the amounts of similar related actions.

For example, if M_A(j, k)=A_u(i), the action amount calculation unit 3002 calculates Q(j, k)=Q(j, k)+{De_u(i)−Ds_u(i)}. The action amount calculation unit 3002 calculates Q(j, k) for every M_A(j, k) and then normalizes it per unit time, thereby updating Q(j, k). For example, the action amount calculation unit 3002 calculates Q(j, k)=Q(j, k)/{Ta_x+Tb_x}.

Here, the case has been described where the action amount calculation unit 3002 calculates the amount Q(j, k) of a related action based on the total time during which the target person performs the related action, but the present embodiment is not limited to this. For example, the action amount calculation unit 3002 may calculate the amount Q(j, k) of a related action based on the average time of performing the related action per target person.

Furthermore, for example, the action amount calculation unit 3002 may calculate the amount Q(j, k) of a related action based on the total number of persons who have performed the related action or the average number of persons. In addition, for example, the action amount calculation unit 3002 may calculate the amount Q(j, k) of a related action based on the total area or the average area of the places where the target person performed the related action.

When it is determined that there is no problem in the operation, the action amount calculation unit 3002 calculates the average value of the amounts of related actions at the time point when it is determined that there is no problem in the operation, and stores the average value as the amount Q_ave(j, k) of a related action in normal times in the normal time-related action amount management table 1500. The action amount calculation unit 3002 calculates the amount Q_ave(j, k) of a related action in normal times by a method similar to that for the amount Q(j, k) of a related action. The amount Q_ave(j, k) of a related action in normal times may be set to a specified value in the initial state. The action amount calculation unit 3002 periodically updates, for example, the amount Q_ave(j, k) of a related action in normal times. The “periodically” is, for example, once a month.

The cause identification unit 3003 acquires a margin M(j, k) for comparison based on the margin management table 1600. The margin M(j, k) is set in advance, for example, according to the index value and characteristics of the related action. The margin M(j, k) may be set by machine learning, for example.

The cause identification unit 3003 identifies a cause C based on the result of comparing Q(j, k) with Q_ave(j, k) by referring to the change pattern management table 1000. The cause identification unit 3003 identifies, for example, C=M_C(j) if M_P(j, k)=− and Q(j, k)<Q_ave(j, k)−M(j, k). The cause identification unit 3003 identifies, for example, C=M_C(j) if M_P(j, k)=+ and Q(j, k)>Q_ave(j, k)+M(j, k). When a plurality of Cs is identified, the cause identification unit 3003 identifies the plurality of Cs as the cause of the problem in the operation. Next, description of FIG. 32 will be made.

In FIG. 32, the display control unit 3004 generates a screen 3200. The screen 3200 includes an index value graph 3210, a graph 3221 of actions associated with the name of A staff, a graph 3222 of actions associated with the name of B staff, and a graph 3223 of actions associated with the name of C staff.

On the screen 3200, the related action “waiting at center” that has become an index when identifying the cause “emergency transport”, the action “transport” that has become the cause “emergency transport”, and the target person “B staff” who has performed the action “transport” are displayed in a specific display mode. In the example of FIG. 32, the specific display mode is the mode surrounded by a rectangle. The screen 3200 further includes a list 3230 of the related action “waiting at center” that has become an index when identifying the cause “emergency transport”, the action “transport” that has become the cause “emergency transport”, and the target person “B staff” who has performed the action “transport”. The display control unit 3004 transmits a generated display request of the screen 3200 to the manager terminal 203 to thereby cause display of the screen 3200 on the manager terminal 203.

Thus, the information processing device 100 may enable the manager to grasp a direct or superficial reason why the problem has occurred in the operation directly or superficially by referring to the related action “waiting at center” that has become an index when the manager identifies the cause “emergency transport”. Furthermore, the information processing device 100 may enable the manager to grasp an indirect or potential cause that the problem has occurred in the operation by referring to the action “transport” that has become the cause “emergency transport”, and the target person “B staff” who has performed the action “transport”. Therefore, the information processing device 100 may reduce the work load, the work time, the mental burden, and the like on the manager.

For example, when a problem “cartel is formed” has occurred in the operation, the information processing device 100 may enable the manager to grasp a potential cause such as “approached by another company” besides a direct reason “sharing bid information with other companies”. Furthermore, there may be a plurality of potential causes that cause a problem in the operation. Accordingly, the information processing device 100 may identify what reason such as “properly handed over by boss” or “approached by another company” the potential cause is, and the potential cause may be identified accurately.

For example, the information processing device 100 may enable to grasp the direct reason “no nurses are waiting at the nurse center” when the problem “response time to a nurse call is long” has occurred in the operation. Moreover, the information processing device 100 may enable the manager to grasp a potential cause such as “emergency transport has been scheduled”. Furthermore, there may be a plurality of potential causes that cause a problem in the operation. Accordingly, the information processing device 100 may identify what reason such as “emergency transport has been scheduled”, “few nurses have been on duty”, or “the number of nurse calls has been higher than in normal times” the potential cause is, and may accurately identify the potential cause.

(Second Specific Example of Operation of Information Processing Device 100)

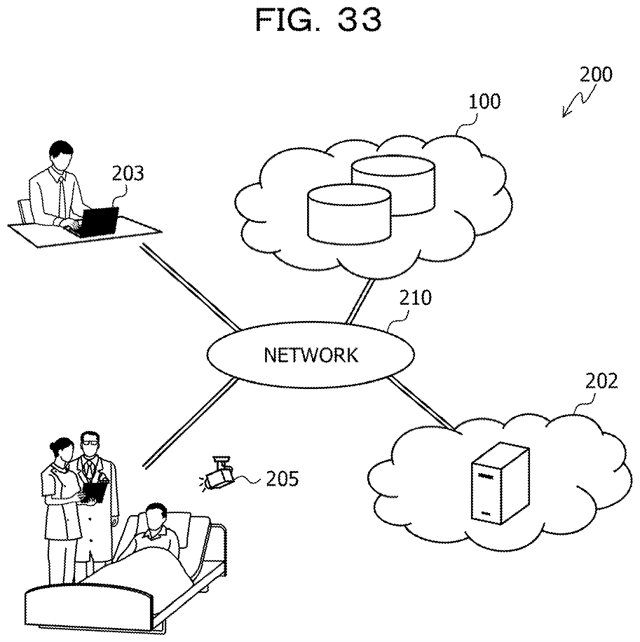

Next, a second specific example of operation of the information processing device 100 will be described with reference to FIGS. 33 to 35. The second specific example corresponds to a case where the information processing device 100 collects sensor data indicating actions of target persons from the state detection device 205 and acquires time-series data of the actions.

First, a configuration example of the information processing system 200 in the second specific example will be described with reference to FIG. 33.

FIG. 33 is an explanatory diagram illustrating a configuration example of the information processing system 200 in the second specific example. In the second specific example, the information processing system 200 includes the information processing device 100, the index value management device 202, the manager terminal 203, and the state detection device 205. Here, the information processing device 100 may be implemented on the cloud. The index value management device 202 may be implemented on the cloud.

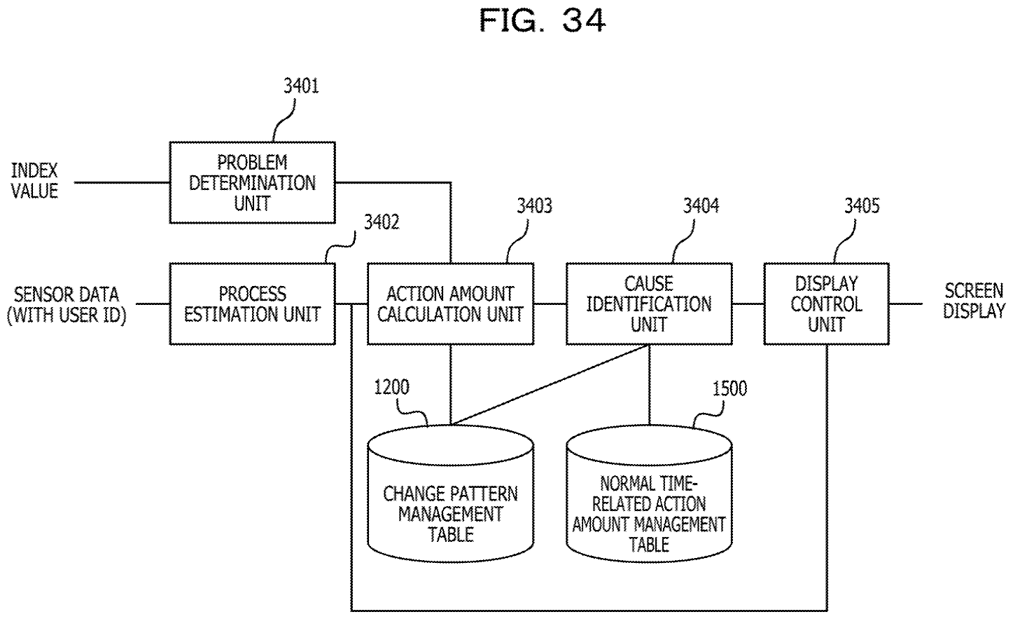

Next, a specific example of a functional configuration of the information processing device 100 in the second specific example will be described with reference to FIG. 34.

FIG. 34 is an explanatory diagram illustrating a specific example of the functional configuration of the information processing device 100 in the second specific example. In FIG. 34, the information processing device 100 includes a problem determination unit 3401, a process estimation unit 3402, an action amount calculation unit 3403, a cause identification unit 3404, and a display control unit 3405. The information processing device 100 has a change pattern management table 1200 and a normal time-related action amount management table 1500.

The information processing device 100 acquires one or more pieces of sensor data associated with the user ID, and acquires one or more pieces of time-series data of actions based on the one or more pieces of sensor data. The sensor data includes, for example, video of a target person, voice of a target person, or the like. The sensor data includes, for example, a usage log of a predetermined device, a usage log of a predetermined system, a usage log of a predetermined service, and the like. The sensor data includes, for example, an acceleration of a target person, biological information of a target person, and the like. The information processing device 100 acquires one or more pieces of time-series data of an index value.

The process estimation unit 3402 recognizes an action of a target person at each time point based on the sensor data associated with the user ID, and generates time-series data of the action. The process estimation unit 3402 may further generate an index value based on the sensor data associated with the user ID. The problem determination unit 3401 determines whether or not a problem is present at each time point based on the index value, and identifies a problem occurrence time point. The action amount calculation unit 3403 identifies a predetermined time zone including a before and after time on the basis of the problem occurrence time point as a problem occurrence time and, based on the time-series data of the action, extracts an action corresponding to a related action in the problem occurrence time and calculates the amount of a related action. The cause identification unit 3404 compares the amount of a related action in normal times with the amount of a related action in the problem occurrence time, and identifies a cause corresponding to a comparison result based on the change pattern management table 1200. The display control unit 3405 displays the related action and the cause on the manager terminal 203 in association with the time-series data of the action.

Next, the second specific example of operation of the information processing device 100 will be described. The state detection device 205 has an image pickup device and, when an image of a target person is detected by face recognition technology, transmits sensor data including the image of the target person, the time point of capturing the image, and the position of the state detection device 205 to the information processing device 100 in association with the user ID that identifies the target person. The information processing device 100 acquires the sensor data associated with the user ID from the state detection device 205.

The information processing device 100 acquires an index value I_x(t) from the index value management device 202. It is assumed that the index value management device 202 is included in an existing operation system and calculates the index value I_x(t), for example. In the following description, it is assumed that the index value I_1(t) is a response time to a nurse call in a medical ward.

The index value I_x(t) may be, for example, a production quantity, the number of defective products, a yield, the number of accidents, or the like, as long as it is a value related to the manufacturing industry. The index value I_x(t) may be, for example, an average processing time, a talk time, a post-processing time, a response rate, an average response speed, or the like, as long as it is a value related to a call center.

Based on the sensor data, the process estimation unit 3402 acquires a combination of the user ID=u′, the action start time point Ds_u′(i), the action end time point De_u′(i), and the action name A_u′(i) and stores them in the action management table 500.

It is assumed that the action name is associated with a place in advance, for example. For example, if the target person is in a hospital room, the process estimation unit 3402 identifies an action name “response to patient” associated with the hospital room. For example, if the target person is in an operating room, the process estimation unit 3402 identifies an action name “surgery” associated with the operating room. For example, if the target person is in the nurse center, the process estimation unit 3402 identifies the action name “waiting at center” associated with the nurse center. The process estimation unit 3402 may recognize the action of the target person based on a plurality of types of sensor data.

At this time, the process estimation unit 3402 may further generate an index value based on the sensor data. The index value is, for example, a user ID for identifying a target person in a predetermined place, information for identifying an attribute of the target person in a predetermined place, or the like. The attribute is, for example, a job title. The job title is, for example, doctor, nurse, clerk, or the like.

The problem determination unit 3401 combines the index value I_x(t) and the new index value generated by the process estimation unit 3402 together to set an index value I′_x(t). The problem determination unit 3401 acquires a condition corresponding to I′_x(t) based on the condition management table 700. The problem determination unit 3401 monitors I′_x(t) and sets a time point when the acquired condition is satisfied to the problem occurrence time point T. At this time, after determining that the condition is satisfied once, the problem determination unit 3401 does not update the problem occurrence time point T until a certain time elapses after the condition is no longer satisfied. The fixed time is, for example, thirty seconds.

In the change pattern management table 1200, with an item number j′ and a number k′ of action or the like, an index value tag M_I′(j′)=Index value number x, a related action M_A′(j′, k′), a change pattern M_P′(j′, k′) of the related action, and a cause M_C′(j′) are associated and stored. The change pattern management table 1200 may be updated sequentially.

The action amount calculation unit 3403 sets a search time range T−Ta_x to T+Tb_x on the basis of the problem occurrence time point T by referring to the search width management table 1300. For example, Ta_1=20 minutes corresponding to the index value number 1 and Tb_1=0 minutes corresponding to the index value number 1. Ta_x and Tb_x are set in advance, for example, according to characteristics of the index value.

The action amount calculation unit 3403 searches for A_u′(i) that matches M_A(j′, k′) in the search time range. The action amount calculation unit 3403 calculates a normalized amount Q(j′, k′) of a related action if there is A_u′(i) that matches M_A′(j′, k′). The amount Q(j′, k′) of a related action is calculated, for example, based on the total number of persons who have performed the related action.

For example, if M_A′(j′, k′)=A_u′(i), the action amount calculation unit 3403 calculates Q′(j′, k′)=Q′(j′, k′)+1. The action amount calculation unit 3403 calculates Q′(j′, k′) for every M_A′(j′, k′) and then normalizes it per unit time, thereby updating Q′(j′, k′). For example, the action amount calculation unit 3403 calculates Q′(j′, k′)=Q′(j′, k′)/{Ta_x+Tb_x}.

The action amount calculation unit 3403 calculates the average value of the amounts of related actions in a time width in which it is determined that there is no problem in the operation within the predetermined time width, and stores the average value in the normal time-related action amount management table 1500 as the amount Q′_ave(j′, k′) of a related action in normal times in association with the time width. The predetermined time width is, for example, each period such as between 0 and 1 o'clock, between 1 and 2 o'clock, or between 2 and 3 o'clock.

The action amount calculation unit 3403 calculates the amount Q′_ave(j′, k′) of a related action in normal times by a method similar to that for the amount Q(j′, k′) of a related action. The amount Q′_ave(j′, k′) of a related action in normal times may be set to a default value in the initial state. The action amount calculation unit 3403 periodically updates, for example, the amount Q′_ave(j′, k′) of a related action in normal times. The “periodically” is, for example, once a month.

The cause identification unit 3404 acquires a margin M(j′, k′) for comparison based on the margin management table 1600. The margin M(j′, k′) is set in advance, for example, according to the index value and characteristics of the related action. The margin M(j′, k′) may be set by machine learning, for example. The cause identification unit 3404 acquires the amount Q′_ave(j′, k′) of a related action in normal times associated with the period corresponding to the problem occurrence time point T in each period such as between 0 and 1 o'clock, between 1 and 2 o'clock, or between 2 and 3 o'clock.

The cause identification unit 3404 identifies a cause C based on the result of comparing Q′(j′, k′) with Q′_ave(j′, k′) by referring to the change pattern management table 1200. The cause identification unit 3404 identifies, for example, C=M_C(j′) if M_P(j′, k′)=− and Q′(j′, k′)<Q′_ave(j′, k′)−M(j′, k′). The cause identification unit 3404 identifies, for example, C=M_C(j′) if M_P(j′, k′)=+ and Q′(j′, k′)>Q′_ave(j′, k′)+M(j′, k′).

If there is a plurality of pairs of the related action or the related index value and the change pattern, the cause identification unit 3404 identifies C=M_C(j′) when the conditions indicated by all the pairs are satisfied. When a plurality of causes Cs has been identified, the cause identification unit 3404 identifies the plurality of causes Cs as the cause of the problem in the operation.

When no cause Cs have been identified, the cause identification unit 3404 may accept an input of the cause C from the manager by communicating with the manager terminal 203, and the change pattern management table 1200 may be updated based on the input cause C.

In this case, the cause identification unit 3404 calculates an action amount Sq(I) similarly to the action amount calculation unit 3403, for example. The cause identification unit 3404 identifies, for example, all action names based on A_u′(i), and stores them in the analysis information management table 1700 as action names Sn(I).

The cause identification unit 3404 calculates, for example, in the search time range T−Ta_x to T+Tb_x, the number of target persons taking the action with the action name Sn(I) as the amount of action Sq(I) in the problem occurrence time. For example, the cause identification unit 3404 normalizes the amount of action Sq(I) in the problem occurrence time per unit time, and stores the amount of action Sq(I) in the problem occurrence time after the normalization in the analysis information management table 1700. For example, the cause identification unit 3404 performs normalization by Sq(I)=Sq(I)/{Ta_x+Tb_x}.

The cause identification unit 3404 calculates, for example, the amount of action Sq_ave(I) in the normal time zone. For example, the cause identification unit 3404 acquires the search width Tc based on the analysis information management table 1700. For example, the cause identification unit 3404 calculates the number of target persons taking the action with the action name Sn(I) in the normal time zone T+Tb_x to T+Tb_x+Tc as the amount of action Sq_ave(I) in the normal time zone.

For example, the cause identification unit 3404 normalizes the amount of action Sq_ave(I) in the normal time zone per unit time, and stores the amount of action Sq_ave(I) in the normal time zone after the normalization in the analysis information management table 1700. For example, the cause identification unit 3404 performs normalization by Sq_ave(I)=Sq_ave(I)/Tc.

The cause identification unit 3404 compares, for example, the amount of action Sq(I) in the problem occurrence time with the amount of action Sq_ave(I) in the normal time zone. For example, the cause identification unit 3404 identifies a pair of the action name R_A and the change pattem R_P to be a candidate for associating with the cause of the problem in the operation based on a comparison result, and stores the pair in the candidate management table 1900.

For example, the cause identification unit 3404 acquires a threshold TH5 and a threshold TH6 based on the candidate determination threshold management table 1800. For example, if Sq(I)−Sq_ave(I)>TH5, the cause identification unit 3404 sets R_A←Sn(I) and R_P←+. For example, if Sq_ave(I)−Sq(I)>TH6, the cause identification unit 3404 sets R_A←Sn(I) and R_P←−.

The cause identification unit 3404 transmits, for example, the pair of the action name R_A and the change pattern R_P to the manager terminal 203 based on the candidate management table 1900. The manager terminal 203 outputs the received pair of the action name R_A and the change pattern R_P so that the manager is able to refer to the information, and accepts an instruction from the manager as to whether or not to associate the pair of the action name R_A and the change pattern R_P with the cause. When the manager terminal 203 accepts the instruction for associating the cause, the manager terminal 203 further accepts the input of the cause.

The manager terminal 203 transmits an instruction as to whether or not to associate the cause to the cause identification unit 3404 and, if there is an input cause, also transmits the input cause to the cause identification unit 3404. Upon receiving the instruction for associating the cause and the input cause, the cause identification unit 3404 associates the pair of the action name R_A and the change pattern R_P with the input cause, and adds them to the change pattern management table 1200. The cause identification unit 3404 sets, for example, M_I(j)←a value that does not overlap with the existing index value number x, M_A(j, k)←R_A, M_P(j, k)←R_P, M_C(j)←the input cause, and adds them to the change pattern management table 1200. Thus, the cause identification unit 3404 makes it possible to accurately identify the cause of the problem in the operation in the future.

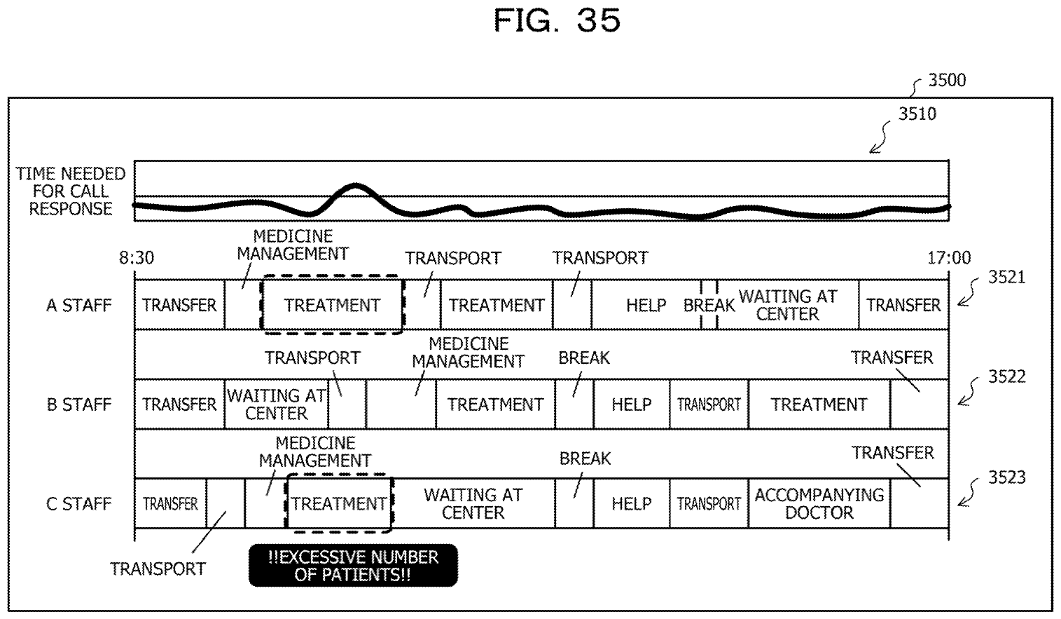

Next, a display example in the second specific example will be described with reference to FIG. 35.

FIG. 35 is an explanatory diagram illustrating the second specific example of operation of the information processing device 100. In FIG. 35, the display control unit 3405 generates a screen 3500. The screen 3500 includes an index value graph 3510, a graph 3521 of actions associated with the name of A staff, a graph 3522 of actions associated with the name of B staff, and a graph 3523 of actions associated with the name of C staff.

On the screen 3500, a message “!!Excessive number of patients!!” indicating the cause “excessive number of patients” is displayed together with the graphs 3521 to 3523. On the screen 3500, the related action “treatment” that has become an index when identifying the cause “excessive number of patients”, is displayed in a specific display mode. The display control unit 3405 transmits a generated display request of the screen 3500 to the manager terminal 203 to thereby cause display of the screen 3500 on the manager terminal 203.

Thus, the information processing device 100 may include a message indicating the cause on the screen 3500 even in a situation where the action of the target person is not a cause of the problem in the operation. The information processing device 100 may enable the manager to grasp a direct or superficial reason why the problem has occurred in the operation by referring to the related action “treatment” that has become an index when the manager identifies the cause “excessive number of patients”. Furthermore, the information processing device 100 may enable the manager to grasp the indirect or potential cause of the problem in the operation by referring to a message. Therefore, the information processing device 100 may reduce the work load, the work time, the mental burden, and the like on the manager.

For example, when a problem “cartel is formed” has occurred in the operation, the information processing device 100 may enable the manager to grasp a potential cause such as “approached by another company” besides a direct reason “sharing bid information with other companies”. Furthermore, there may be a plurality of potential causes that cause a problem in the operation. Accordingly, the information processing device 100 may identify what reason such as “properly handed over by boss” or “approached by another company” the potential cause is, and the potential cause may be identified accurately.

For example, the information processing device 100 may enable to grasp the direct reason “no nurses are waiting at the nurse center” when the problem “response time to a nurse call is long” has occurred in the operation. Moreover, the information processing device 100 may enable the manager to grasp a potential cause such as “emergency transport has been scheduled”. Furthermore, there may be a plurality of potential causes that cause a problem in the operation. Accordingly, the information processing device 100 may identify what reason such as “emergency transport has been scheduled”, “few nurses have been on duty”, or “the number of nurse calls has been higher than in normal times” the potential cause is, and may accurately identify the potential cause.

(Overall Processing Procedure)

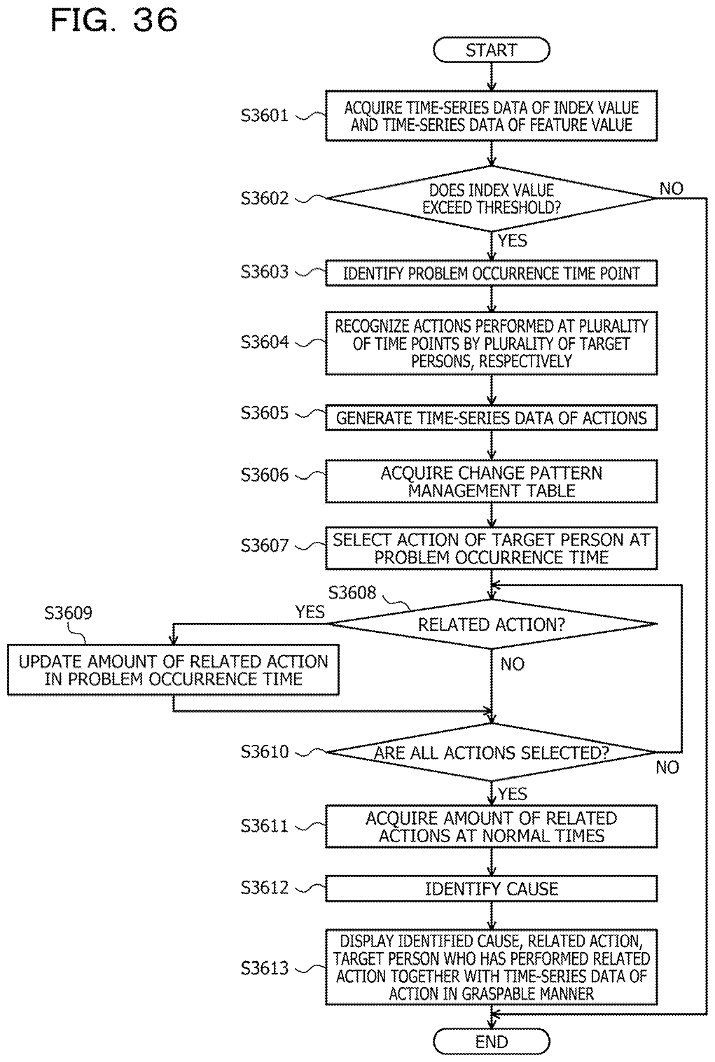

Next, an example of an overall processing procedure executed by the information processing device 100 will be described with reference to FIG. 36. The overall processing is implemented by, for example, the CPU 301, the storage area of the memory 302, the recording medium 305, or the like, and the network I/F 303 illustrated in FIG. 3.

FIG. 36 is a flowchart illustrating an example of an overall processing procedure. In FIG. 36, the information processing device 100 acquires time-series data of an index value and time-series data of a feature value (step S3601). The feature value is, for example, a sensor value.

Next, the information processing device 100 determines whether or not the index value exceeds the threshold (step S3602). Here, when the threshold is not exceeded (No in step S3602), the information processing device 100 ends the overall processing. On the other hand, when the threshold is exceeded (Yes in step S3602), the information processing device 100 proceeds to the processing of step S3603.

In step S3603, the information processing device 100 identifies a problem occurrence time point when the index value exceeds the threshold (step S3603). Next, the information processing device 100 recognizes actions performed at a plurality of time points by the plurality of target persons, respectively, based on the time-series data of the feature value (step S3604). Then, the information processing device 100 generates time-series data of actions recording the actions of every target person (step S3605).

Next, the information processing device 100 acquires the change pattern management tables 1000, 1100, 1200 (step S3606). Then, the information processing device 100 selects an action of a target person in the problem occurrence time including the problem occurrence time point (step S3607).

Next, the information processing device 100 determines whether or not the selected action is a related action based on the change pattern management tables 1000, 1100, 1200 (step S3608). Here, when it is a related action (Yes in step S3608), the information processing device 100 proceeds to the processing of step S3609. On the other hand, when it is not a related action (No in step S3608), the information processing device 100 proceeds to the processing of step S3610.

In step S3609, the information processing device 100 updates the amount of a related action in the problem occurrence time (step S3609). Then, the information processing device 100 proceeds to the processing of step S3610.

In step S3610, the information processing device 100 determines whether or not all actions have been selected (step S3610). Here, when there is an action that has not been selected (No in step S3610), the information processing device 100 returns to the processing of step S3608. On the other hand, when all the actions have been selected (Yes in step S3610), the information processing device 100 proceeds to the processing of step S3611.

In step S3611, the information processing device 100 acquires the amount of a related action in normal times (step S3611). Next, the information processing device 100 refers to the change pattern management tables 1000, 1100, 1200 and identifies the cause based on a result of comparing the calculated amount of a related action with the acquired amount of a related action in normal times (step S3612).

Then, the information processing device 100 displays the identified cause, the related action, and the target person who has performed the related action together with the time-series data of the action in a graspable manner (step S3613). Thereafter, the information processing device 100 ends the overall processing.

Here, the information processing device 100 may execute the processing of part of the steps in FIG. 36 in a different order. Furthermore, the information processing device 100 may omit the processing of part of the steps in FIG. 36.

As described above, with the information processing device 100, it is possible to detect that an index value with respect to a predetermined event has satisfied a predetermined condition. With the information processing device 100, it is possible to acquire an amount of an action related to the event in a time zone corresponding to a time point when the index value with respect to the event has satisfied the condition based on first information that allows identifying an action performed by a target person at each of a plurality of time points. With the information processing device 100, it is possible to compare the acquired amount of the action related to the event in the time zone with an amount of an action related to the event in a past time zone. With the information processing device 100, a cause corresponding to a comparison result may be identified based on second information that allows identifying, with respect to a case where a cause for the index value with respect to the event to satisfy the condition has not occurred, a change tendency of an amount of an action related to the event when the cause has occurred. Thus, the information processing device 100 may identify the cause that the index value with respect to the predetermined event has satisfied the predetermined condition. In other words, the information processing device 100 may identify the cause of a problem in the operation.

With the information processing device 100, it is possible to store the second information that allows identifying, with respect to a case where a cause for the index value with respect to the event to satisfy the condition has not occurred, a change tendency of an amount of each of a plurality of actions related to the event when the cause has occurred. With the information processing device 100, it is possible to acquire an amount of each of a plurality of actions related to the event in the time zone based on the first information. With the information processing device 100, it is possible to compare the acquired amount of each of the plurality of actions related to the event in the time zone with the amount of each of a plurality of actions related to the event in the past time zone. With the information processing device 100, it is possible to identify a cause corresponding to a comparison result based on the second information. Thus, the information processing device 100 may identify the cause that the index value with respect to the predetermined event has satisfied the predetermined condition based on the plurality of actions.

With the information processing device 100, it is possible to store the second information that allows identifying, with respect to a case where a cause for the index value with respect to the event to satisfy the condition has not occurred, a change tendency of an amount of an action and a change tendency of a statistical value of another index value related to an index value when a cause has occurred. With the information processing device 100, it is possible to acquire a statistical value of another index value related to an index value with respect to the event in the time zone. With the information processing device 100, it is possible to compare the amount of the action related to the event in the time zone and a statistical value of the another index value related to the index value with respect to the event, with the amount of the action related to the event in the past time zone and a statistical value of the another index value related to the index value with respect to the event. With the information processing device 100, it is possible to identify a cause corresponding to a comparison result based on the second information. Thus, the information processing device 100 may identify the cause that the index value with respect to the predetermined event has satisfied the predetermined condition by referring to another index value in addition to the action.

With the information processing device 100, the second information may be updated based on input information that allows identifying, with respect to a case where a cause for the index value with respect to the event to satisfy the condition has not occurred, a change tendency of an amount of an action related to the event when the cause has occurred. Thus, the information processing device 100 may improve the accuracy of identifying the cause that the index value with respect to the predetermined event has satisfied the predetermined condition.

With the information processing device 100, as a result of comparison, it is possible to determine whether or not a difference between the amount of an action related to the event in the time zone and the amount of the action related to the event in the past time zone is equal to or less than the threshold. With the information processing device 100, when the value is equal to or less than a threshold, the action related to the event, the change tendency of the amount of an action related to the event in the time zone with respect to the past time zone, and the event may be output in association with each other. With the information processing device 100, as a result of the output, the second information may be updated based on input information that allows identifying a cause for the index value with respect to the event to satisfy the condition. Thus, the information processing device 100 may improve the accuracy of identifying the cause that the index value with respect to the predetermined event has satisfied the predetermined condition.

With the information processing device 100, it is possible to display actions performed by the target person at each of the plurality of time points along the time axis. With the information processing device 100, when the cause is an action performed by the target person at any of the plurality of time points, at least one of the target person, an action to be the cause, or the action related to the event in the displayed time axis may be displayed in a specific display mode. Thus, the information processing device 100 may make it easy to grasp the cause that the index value with respect to the predetermined event has satisfied the predetermined condition.

With the information processing device 100, it is possible to display actions performed by the target person at each of the plurality of time points along the time axis. With the information processing device 100, it is possible to display a message indicating the identified cause together with the time axis. Thus, the information processing device 100 may make it easy to grasp the cause that the index value with respect to the predetermined event has satisfied the predetermined condition.

With the information processing device 100, the plurality of actions may be grouped based on a name that identifies each of the plurality of actions. With the information processing device 100, it is possible to acquire a statistic based on an amount of each of one or more actions belonging to a group including the action related to the event in the time zone based on the first information. With the information processing device 100, it is possible to compare the acquired statistic with a statistic based on an amount of each of one or more actions belonging to a group including the action related to the event in the past time zone. With the information processing device 100, a cause corresponding to a comparison result may be identified based on second information that allows identifying, with respect to a case where a cause for the index value with respect to the event to satisfy the condition has not occurred, a change tendency of an amount of an action related to the event when the cause has occurred. Thus, the information processing device 100 may be applied when there is a notational variation in the action name, and it is possible to improve the accuracy of identifying the cause that the index value with respect to the predetermined event has satisfied the predetermined condition.

With the information processing device 100, the first information may be generated based on a result of recognizing a state of the target person using a predetermined sensor. Thus, the information processing device 100 may be applied to a situation in which the target person does not record his or her own action schedule.

With the information processing device 100, as the amount of the action related to the event, it is possible to employ a statistic related to a number of the target persons who have performed the action related to the event, a statistic related to a time when the action related to the event has been performed, or a statistic related to a size of an area where the action related to the event has been performed. Thus, the information processing device 100 may employ the amount of an action having useful characteristics for identifying the cause that the index value with respect to the predetermined event has satisfied the predetermined condition.

With the information processing device 100, as the time zone, it is possible to employ a time point when the index value with respect to the event has satisfied the condition. Thus, the information processing device 100 may identify the cause that the index value with respect to the predetermined event has satisfied the predetermined condition based on the amount of action at the time point when the index value with respect to the event has satisfied the condition.

With the information processing device 100, it is possible to employ, as the time zone, a time width of a predetermined length including a time point when the index value with respect to the event has satisfied the condition. Thus, the information processing device 100 may identify the cause that the index value with respect to the predetermined event has satisfied the predetermined condition based on the amount of action in the time zone including the time point when the index value with respect to the event has satisfied the condition. Therefore, the information processing device 100 may refer to actions before or after a problem occurs in the operation, and improve the accuracy of identifying the cause that the index value with respect to the predetermined event has satisfied the predetermined condition.

With the information processing device 100, it is possible to employ, as the condition, that the index value is out of a predetermined range. Thus, the information processing device 100 may determine that a problem has occurred when the index value is out of the predetermined range.

With the information processing device 100, it is possible to employ, as the condition, that the target person identified by the index value is other than a specific target person. Thus, the information processing device 100 may determine that a problem has occurred when the target person identified by the index value is other than the specific target person.

Note that the information processing method described in the present embodiment may be implemented by executing a prepared program on a computer such as a personal computer or a workstation. The information processing program described in the present embodiment is executed by being recorded on a computer-readable recording medium and being read from the recording medium by the computer. Recording media are hard disks, flexible disks, compact disc (CD)-ROM, magneto-optical disc (MO), digital versatile disc (DVD), and so on. Furthermore, the information processing program described in the present embodiment may be distributed via a network such as the Internet.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable storage medium for storing a program which causes a processor to perform processing, the processing comprising:
detecting that an index value with respect to a predetermined event has satisfied a predetermined condition;
acquiring an amount of an action related to the event in a time zone corresponding to a time point when the index value with respect to the event has satisfied the condition based on first information that allows identifying an action performed by a target person at each of a plurality of time points;
comparing the acquired amount of the action related to the event in the time zone with an amount of an action related to the event in a past time zone; and
identifying a cause corresponding to a comparison result based on second information that allows identifying, with respect to a case where a cause for the index value with respect to the event to satisfy the condition has not occurred, a change tendency of an amount of an action related to the event when the cause has occurred.

2. The non-transitory computer-readable storage medium according to claim 1, wherein
the acquiring acquires an amount of each of a plurality of actions related to the event in the time zone based on the first information,
the comparing compares the acquired amount of each of the plurality of actions related to the event in the time zone with an amount of each of a plurality of actions related to the event in the past time zone, and
the identifying identifies a cause corresponding to a result of the comparison based on the second information that allows identifying, with respect to a case where a cause for the index value with respect to the event to satisfy the condition has not occurred, a change tendency of an amount of each of a plurality of actions related to the event when the cause has occurred.

3. The non-transitory computer-readable storage medium according to claim 1, the processing further comprising acquiring a statistical value of another index value related to an index value with respect to the event in the time zone, wherein
the comparing compares the amount of the action related to the event in the time zone and a statistical value of the another index value related to the index value with respect to the event, with the amount of the action related to the event in the past time zone and a statistical value of the another index value related to the index value with respect to the event, and
the identifying identifies a cause corresponding to the comparison result based on the second information that allows identifying, with respect to a case where a cause for the index value with respect to the event to satisfy the condition has not occurred, a change tendency of an amount of each of a plurality of actions related to the event and a change tendency of a statistical value of another index value related to an index value with respect to the event when the cause has occurred.

4. The non-transitory computer-readable storage medium according to claim 1, the processing further comprising updating the second information based on input information that allows identifying, with respect to a case where a cause for the index value with respect to the event to satisfy the condition has not occurred, a change tendency of an amount of an action related to the event when the cause has occurred.

5. The non-transitory computer-readable storage medium according to claim 1, the processing further comprising:
when a difference between the amount of the action related to the event in the time zone and the amount of the action related to the event in the past time zone is equal to or less than the threshold as a result of the comparison, outputting the action related to the event, a change tendency of the amount of the action related to the event in the time zone with respect to the past time zone, and the event in association with each other; and
updating, as a result of the output, the second information based on input information that allows identifying a cause for the index value with respect to the event to satisfy the condition.

6. The non-transitory computer-readable storage medium according to claim 1, the processing further comprising:
displaying actions performed by the target person at each of the plurality of time points along a time axis; and
when the cause is an action performed by the target person at any of the plurality of time points, displaying at least one of the target person, an action to be the cause, or the action related to the event in the displayed time axis in a specific display mode.

7. The non-transitory computer-readable storage medium according to claim 1, the processing further comprising:
displaying actions performed by the target person at each of the plurality of time points along a time axis; and
displaying a message indicating the identified cause together with the time axis.

8. The non-transitory computer-readable storage medium according to claim 1, the processing further comprising:
grouping the plurality of actions based on a name that identifies each of the plurality of actions, wherein
the acquiring acquires a statistic based on an amount of each of one or more actions belonging to a group including the action related to the event in the time zone based on the first information,
the comparing compares the acquired statistic with a statistic based on an amount of each of one or more actions belonging to a group including the action related to the event in the past time zone,
the identifying identifies a cause corresponding to a comparison result based on second information that allows identifying, with respect to a case where a cause for the index value with respect to the event to satisfy the condition has not occurred, a change tendency of an amount of an action related to the event when the cause has occurred.

9. The non-transitory computer-readable storage medium according to claim 1, the processing further comprising:
generating the first information based on a result of recognizing a state of the target person using a predetermined sensor.

10. The non-transitory computer-readable storage medium according to claim 1, wherein the amount of the action related to the event is a statistic related to a number of the target persons who have performed the action related to the event, a statistic related to a time when the action related to the event has been performed, or a statistic related to a size of an area where the action related to the event has been performed.

11. The non-transitory computer-readable storage medium according to claim 1, wherein the time zone is a time point when the index value with respect to the event has satisfied the condition.

12. The non-transitory computer-readable storage medium according to claim 1, wherein the time zone is a time width of a predetermined length including a time point when the index value with respect to the event satisfies the condition.

13. The non-transitory computer-readable storage medium according to claim 1, wherein the condition indicates that the index value is out of a predetermined range.

14. The non-transitory computer-readable storage medium according to claim 1, wherein
the index value is a value that identifies a target person who has performed an action related to the event, and
the condition indicates that the target person identified by the index value is other than a specific target person.

15. An information processing method implemented by a computer, the method comprising:
detecting that an index value with respect to a predetermined event has satisfied a predetermined condition;
acquiring an amount of an action related to the event in a time zone corresponding to a time point when the index value with respect to the event has satisfied the condition based on first information that allows identifying an action performed by a target person at each of a plurality of time points;
comparing the acquired amount of the action related to the event in the time zone with an amount of an action related to the event in a past time zone; and
identifying a cause corresponding to a comparison result based on second information that allows identifying, with respect to a case where a cause for the index value with respect to the event to satisfy the condition has not occurred, a change tendency of an amount of an action related to the event when the cause has occurred.

16. An information processing device comprising a control unit that performs:
detecting that an index value with respect to a predetermined event has satisfied a predetermined condition;
acquiring an amount of an action related to the event in a time zone corresponding to a time point when the index value with respect to the event has satisfied the condition based on first information that allows identifying an action performed by a target person at each of a plurality of time points;
comparing the acquired amount of the action related to the event in the time zone with an amount of an action related to the event in a past time zone; and
identifying a cause corresponding to a comparison result based on second information that allows identifying, with respect to a case where a cause for the index value with respect to the event to satisfy the condition has not occurred, a change tendency of an amount of an action related to the event when the cause has occurred.
